(19) United States
(12) Patent Application Publication
(10) Pub. No.: US 2023/0117527 A1
(43) Pub. Date: Apr. 20, 2023

(54) METHOD FOR IMPLEMENTING A DIAGONAL OPERATOR ON A RESTRICTED TOPOLOGY VIA A QUANTUM LOGIC CIRCUIT

(71) Applicant: BEIT Inc., Millbrae, CA (US)

(72) Inventors: Jan Tulowiecki, Giebuttow (PL); Konrad Deka, Krakow (PL); Jan Marian Gwinner, Krakow (PL); Witold Jarnicki, Krakow (PL); Lukasz Czerwinski, Wieliczka (PL)

(73) Assignee: BEIT Inc., Millbrae, CA (US)

(21) Appl. No.: 17/936,527

(22) Filed: Sep. 29, 2022

Related U.S. Application Data
(60) Provisional application No. 63/262,651, filed on Oct. 18, 2021.
(60) Provisional application No. 63/284,473, filed on Nov. 30, 2021.
(60) Provisional application No. 63/284,484, filed on Nov. 30, 2021.
(60) Provisional application No. 63/284,486, filed on Nov. 30, 2021.
(60) Provisional application No. 63/284,492, filed on Nov. 30, 2021.

(51) Int. Cl. G06N 10/20

(52) U.S. Cl. CPC G06N 10/20

(57) ABSTRACT

A TDGₙ quantum circuit on n wires includes a first set of circuits and a plurality of CX gates appended to the first set of circuits to generate a plurality of additional circuits, wherein each of the additional circuits is formed by appending a CX gate of the plurality of CX gates in a corresponding one of a plurality of configurations to one circuit of a first set of circuits. The TDGₙ quantum circuit further includes a second set of circuits, wherein the second set of circuits is generated by an iterative selection procedure.

### CROSS-REFERENCE TO RELATED APPLICATIONS

The present U.S. Utility patent application claims priority pursuant to 35 U.S.C. § 119(e) to U.S. Provisional Application No. 63/262,651, entitled “DIAGONAL OPERATOR DECOMPOSITION ON RESTRICTED TOPOLOGIES VIA ENUMERATION OF STATE SUBSETS”, filed Oct. 18, 2021; U.S. Provisional Application No. 63/284,473, entitled “METHOD AND QUANTUM LOGIC CIRCUIT FOR IMPLEMENTING A DIAGONAL OPERATOR ON A RESTRICTED TOPOLOGY”, filed Nov. 30, 2021; U.S. Provisional Application No. 63/284,481, entitled “QUANTUM LOGIC CIRCUIT WITH STATE PERMUTATIONS FOR IMPLEMENTING A DIAGONAL OPERATOR ON A RESTRICTED TOPOLOGY”, filed Nov. 30, 2021; U.S. Provisional Application No. 63/284,486, entitled “QUANTUM LOGIC CIRCUIT FOR IMPLEMENTING A DIAGONAL OPERATOR ON A RESTRICTED TOPOLOGY WITHOUT PERMUTATIONS”, filed Nov. 30, 2021; and U.S. Provisional Application No. 63/284,492, entitled “METHOD FOR IMPLEMENTING A DIAGONAL OPERATOR ON A RESTRICTED TOPOLOGY VIA A QUANTUM LOGIC CIRCUIT”, filed Nov. 30, 2021, all of which are hereby incorporated herein by reference in their entirety and made part of the present U.S. Utility patent application for all purposes.

### BACKGROUND OF THE INVENTION

### Technical Field of the Invention

This invention relates generally to computer systems and particularly to quantum computing techniques and circuits.

### Description of Related Art

Computing devices are known to communicate data, process data, and/or store data. Such computing devices range from wireless smartphones, laptops, tablets, personal computers (PC), work stations, smart watches, connected cars, and video game devices, to web servers and data centers that support millions of web searches, web applications, or on-line purchases every day. In general, a computing device includes a processor, a memory system, user input/output interfaces, peripheral device interfaces, and an interconnecting bus structure.

Classical digital computing devices operate based on data encoded into binary digits (bits), each of which has one of the two definite binary states (i.e., 0 or 1). In contrast, a quantum computer utilizes quantum-mechanical phenomena to encode data as quantum bits or qubits, which can be in superpositions of the traditional binary states.

### BRIEF DESCRIPTION OF THE SEVERAL VIEWS OF THE DRAWING(S)

FIG. 1A is a schematic block diagram of a prior art quantum circuit;

FIG. 1B is a block diagram of an example quantum computing architecture;

FIG. 1C is a block diagram of an example SPA sequence of CX gates;

FIGS. 2A-2N are schematic/block diagrams of example quantum circuits;

FIG. 3A is a flowchart representation of an example method;

FIG. 3B is a schematic/block diagram of an example quantum circuit;

FIG. 4A is a block diagram of an example quantum computing architecture;

FIGS. 4B-4C are schematic/block diagrams of example quantum circuits;

FIGS. 4D-4G are schematic/block diagrams of example equivalency rules;

FIG. 5 is a flow diagram of an example method.

### DETAILED DESCRIPTION OF THE INVENTION

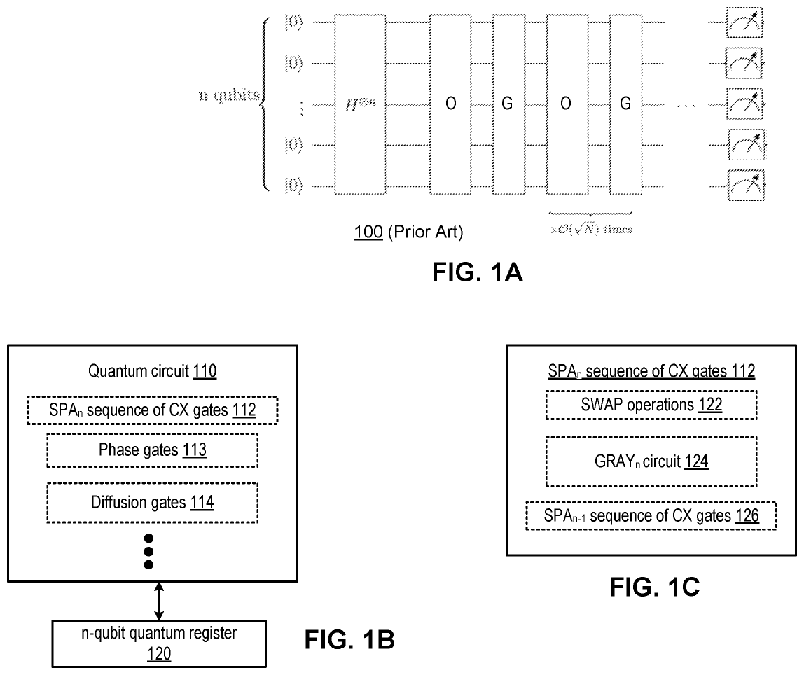

FIG. 1A is a schematic block diagram 100 of a prior art quantum circuit. In particular, a quantum circuit implementation of Grover's algorithm is presented. Grover's algorithm is a quantum algorithm that finds, with high probability, a quantum solution. Grover's algorithm is based on the unique input to a black box function or other function called a “quantum oracle”, “oracle operator”, “oracle function” or simply “oracle” that produces a particular output value. Grover's algorithm converges in just O(sqrt(N)) evaluations of the oracle function, where N is the size of the function's domain. Grover's algorithm has been applied to the problem of unstructured database search, or more generally the inversion of a function.

In operation, n qubits are initialized and applied to a corresponding number of Hadamard (H) gates. Each input is Hadamard transformed in order to achieve a uniform superposition of all the initial states. An oracle gate (O) performs an oracle call for each of the transformed qubit states and a diffusion gate (G) performs the Grover diffusion operator. This process is repeated O(sqrt(N)) times. A measurement of the qubits after this point yields the quantum solution with a probability that approaches 1 for large values of N. See e.g., John Wright, Lecture 4: Grover's Algorithm, Carnegie Mellon University, Sep. 21, 2015.

FIG. 1B is a block diagram of an example quantum computing architecture. Various quantum algorithms, such as Grover search or QAOA, require implementation of arbitrary diagonal operators. Inevitably, to execute those operators on the physical devices, they must be first decomposed into the hardware's native gate set. The decomposition strategy may be greatly impacted by the qubit connectivity of the target device. While this problem has been studied for a fully connected topology, a method of constructing generic diagonal circuits with lower connectivity of qubits, can prove to be of more use in real-life situations.

Appendix A presents a discussion about the structure of solutions in the general case. Three different variants of the problems (independent from target topologies) are presented along with the motivation behind them. In particular, variants called WPA (Wire Permutation Allowed) and SPA (State Permutation Allowed) and their applications in quantum algorithms are presented along with a comprehensive description of a general solution to the decomposition problem on fully connected topology. A solution to the problem on restricted topologies, including linear and circular topologies is presented. Furthermore, a method for generating circuits having the desired properties are also described.

In the example shown, a quantum circuit 110 is presented having n wires (n qubits) that has been generated based on a decomposition of a diagonal operator on a restricted topology—in this case a linear topology, and in a variant where state permutation is allowed. In operation, the quantum circuit 110 generates a quantum computing result based on a measurement from the plurality of qubits—with or without the use of additional (ancillary or ancilla) working qubits. In particular, the quantum circuit 110 can be used in circuit implementations of quantum solutions based on the application of Grover's Algorithm or other diffusion-based quantum solutions.

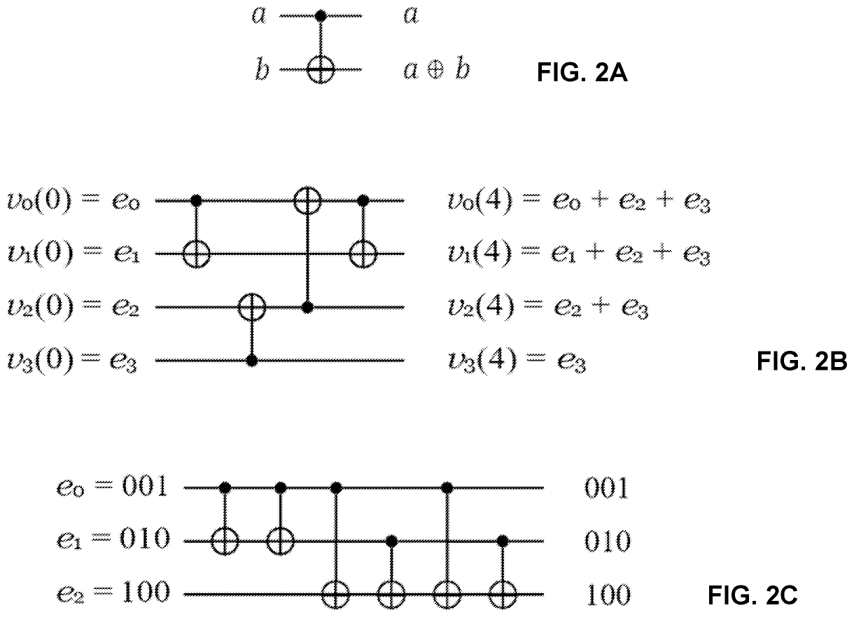

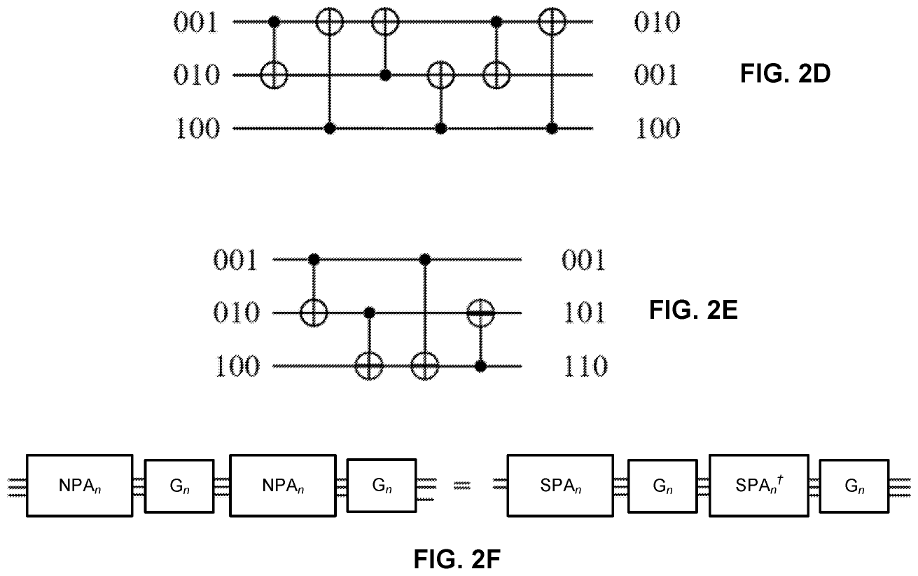

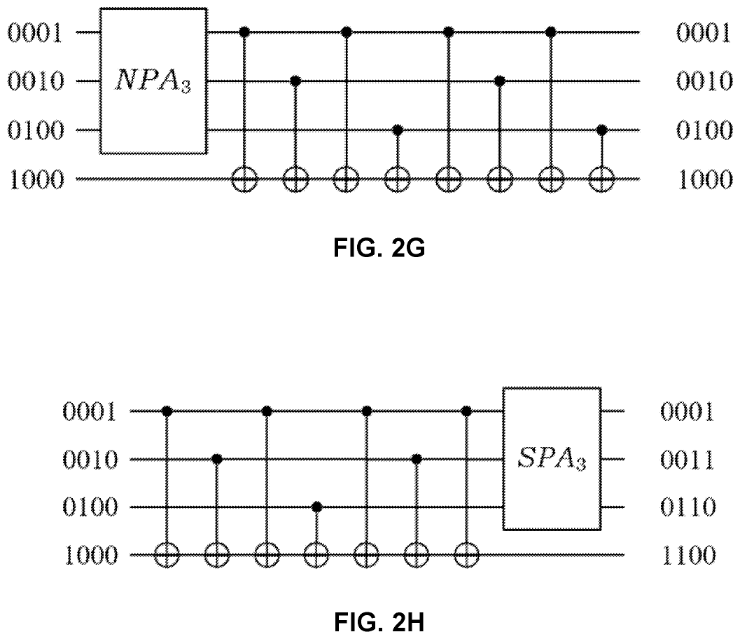

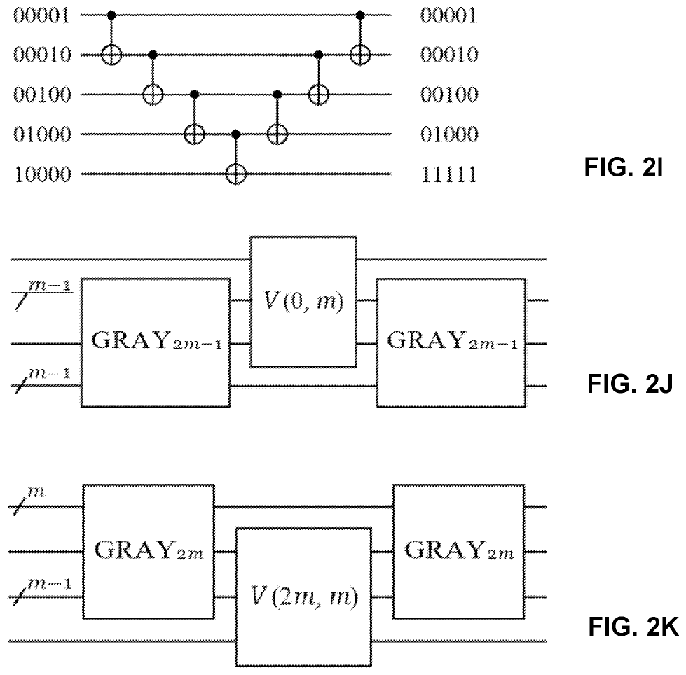

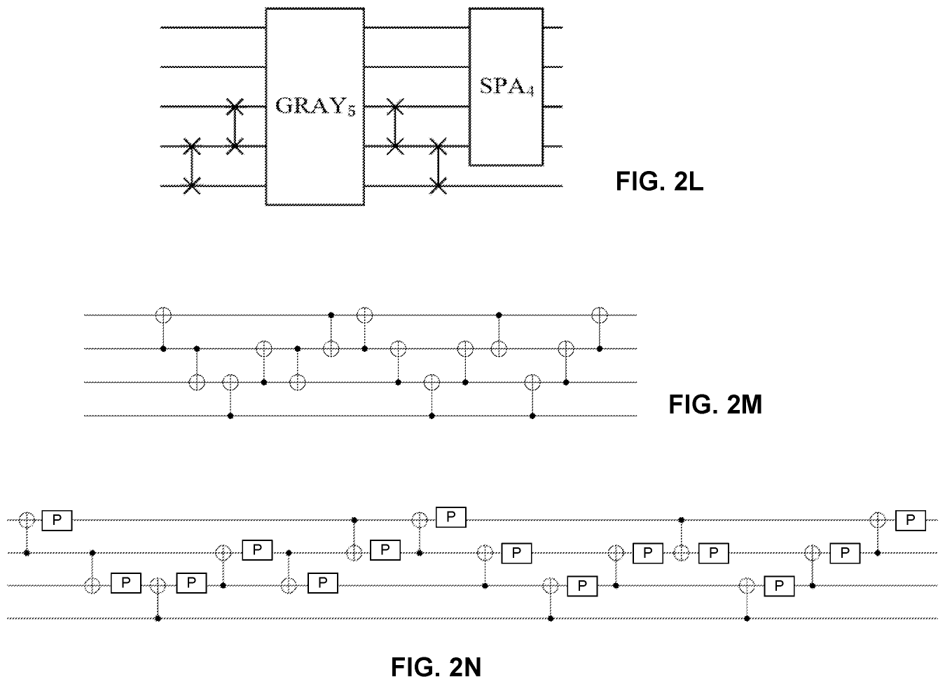

The quantum circuit 110 includes a sequence of CX gates on the n wires in a variant where state permutation is allowed. In the context of this disclosure this can be referred to as SPAₙ sequence of CX gates 112 or more simply as SPAₙ. The quantum circuit 110 further includes phase gates 113. These phase gates can be arranged, for example so that a phase gate is inserted following each of the CX gates of the SPAₙ sequence of CX gates. Consider the example SPA₄ sequence of CX gates shown in FIG. 2M. In FIG. 2N, a phase gate (P) is inserted following each of the CX gates of the SPA₄. The inclusion of these phase gates 113 with the SPAₙ sequence of CX gates 112 creates an SPAₙ circuit (or gate) that can generate, based on the determination of the corresponding phases of the phase gates 113, a quantum solution for any diagonal operator on a linear topology. While a quantum circuit 110 is shown with an SPA implementations, NPA and WPA implementations of quantum circuit 110 can likewise be employed, as discussed in conjunction with Appendix A.

FIG. 1C is a block diagram of an example SPA sequence of CX gates. Following the discussion of Appendix A, SPAₙ can be generated recursively based on SPAₙ₋₁ sequence of gates 126, a GRAYₙ circuit 124 and swap operations 122. Further consider a quantum circuit 110 having z wires. Decomposition can be performed by:

(a) setting n wires, where n=2;

(b) generating a SPAₙ sequence of CX gates on the n wires by:

(c) providing a sequence of at least one forward swap on the n wires;

(d) providing a GRAYₙ circuit on the n wires, wherein the GRAYₙ circuit includes a plurality of additional CX gates;

(e) providing a sequence of at least one reverse swap on the n wires that reverses the operations provided in step (c); and

(f) providing a SPAₙ₋₁ sequence of CX gates on the first n−1 wires of the n wires;

(g) incrementing n and repeating steps (c)-(f);

(h) when n=z, inserting 2ⁿ−1 phase gates in the SPAₙ sequence of CX gates, wherein each of the phase gates has a corresponding phase.

Other iterative and recursive methodologies can likewise be employed.

The quantum circuit 110 further includes diffusion gates 114 such as Grover diffusion gates (G) or other diffusion gates that apply one or more different diffusion operators. The quantum circuit 110 can further include one or more other quantum gates such as, Hadamard (H) gates, X gates, Y gates, Z gates, phase shift gates, other controlled gates, swap gates, Toffoli gates, Deutsch gates, Ising gates, Fredkin gates, Adalus gates and/or other quantum logic gates and combinations thereof in various other circuit configurations.

In various examples, the SPAₙ sequence of CX gates 112, the phase gates 113, and diffusion gates 114, and other gates (when present) of the quantum circuit 110 can be implemented with one or more processing devices. Each such processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. Each such processing device can operate in conjunction with an attached memory and/or an integrated memory element such as classical memory or other memory device, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information.

Note that if the quantum circuit 110 is implemented via more than one processing device, the processing devices may be centrally located (e.g., directly coupled together via a wired and/or wireless bus structure) or may be distributedly located (e.g., cloud computing via indirect coupling via a local area network and/or a wide area network). Further note that if the quantum circuit 110 implements one or more of its gates or other functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, a memory can store, and a processing device can execute, hard coded and/or other operational instructions corresponding to at least some of the steps and/or functions illustrated in one or more of the Figures. Such a memory device or memory element can be tangible memory device or other non-transitory storage medium included in or implemented as an article of manufacture.

Further discussion regarding the operation of the quantum circuit 110, including several optional functions and features are described in conjunction with the figures that follow.

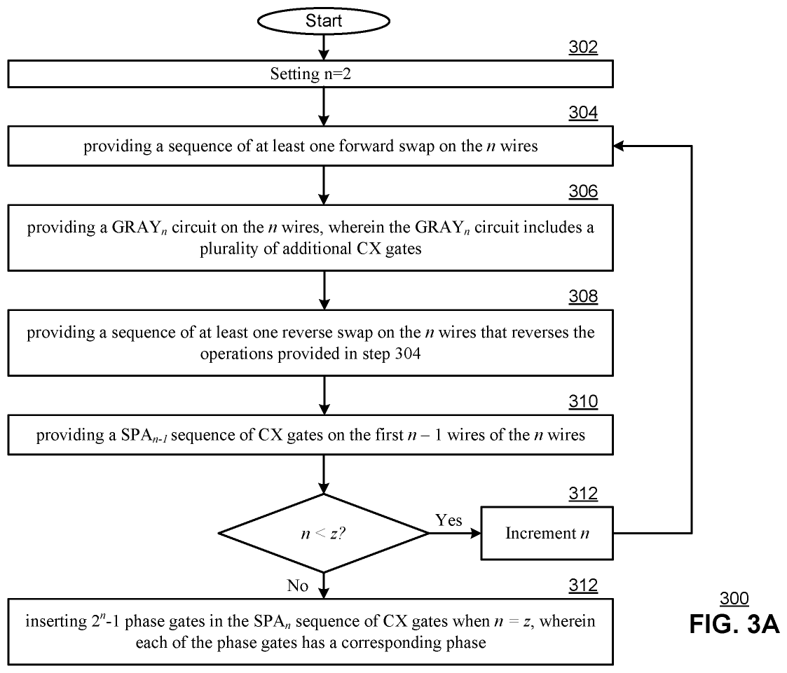

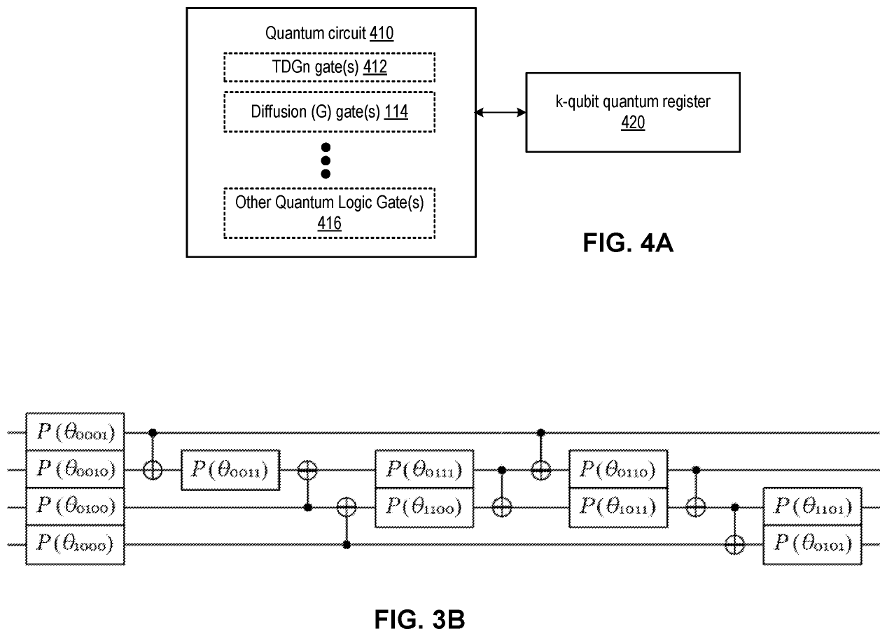

FIG. 3A is a flowchart representation of an example method. In particular a method 300 is presented for use with one or more functions and features described in conjunction herein for generating a quantum circuit having z wires on a restricted topology, where z is greater than 3. Step 302 includes setting n=2. An SPAₙ sequence of CX gates on the n wires is generated by steps 304, 306, 308 and 310. Step 304 includes providing a sequence of at least one forward swap on the n wires. Step 306 includes providing a GRAYₙ circuit on the n wires, wherein the GRAYₙ circuit includes a plurality of additional CX gates. Step 308 includes providing a sequence of at least one reverse swap on the n wires that reverses the operations provided in step 304. Step 310 includes providing a SPAₙ₋₁ sequence of CX gates on the first n−1 wires of then wires. Step 312 includes incrementing n and repeating steps 304-310 when n<z. Step 314 includes inserting 2ⁿ−1 phase gates in the SPAₙ sequence of CX gates when n=z, wherein each of the phase gates has a corresponding phase.

In addition or in the alternative, z=5 and the SPAₙ sequence of CX gates comprises a SPA-TDG₅ sequence of CX gates on five wires.

In addition or in the alternative, each of the phase gates is inserted after a corresponding one of the CX gates of the SPA-TDG₅ sequence of CX gates on a corresponding one of the five wires.

In addition or in the alternative, z=4 and the SPAₙ sequence of CX gates comprises a SPA-TDG₄ sequence of CX gates on four wires.

In addition or in the alternative, each of the phase gates is inserted after a corresponding one of the CX gates of the SPA-TDG₄ sequence of CX gates on a corresponding one of the four wires.

In addition or in the alternative, any of the methods above can be used to generate a quantum circuit having z wires.

While the preceding description provides methodologies for generating quantum circuits on restricted topologies based on sequences of CX gates. There are methods for reducing the number of CS gates in some cases. These techniques can be used to exploiting symmetries contained in a particular diagonal operators to obtain lower CX count compared to the solutions provided by the general framework. Two such methods are presented in Appendix B.

While several techniques have been presented for generating quantum circuits on restricted topologies based on sequences of CX gates, other quantum circuit solutions exist for such problems that minimize or otherwise reduce the number of required CX gates. These solutions on n wires (where n>3) are referred to as Tulowiecki-Deka-Gwinner (TDGₙ) gates (or circuits). This disclosure will also present a nomenclature for describing the particular sequence of CX gates on n wires for such TDGₙ gates, enumerate the TDGₙ gates for n=4 and n=5 for variants NPA (NPA-TDGₙ gates) and SPA (SPA-TDGₙ gates).

An example process of generating TDGₙ gates can be described as follows. In particular, a method is described for finding relatively short circuits solving the Diagonal Operator Decomposition problem (and its respective variants) on restricted topologies. This method produces TDGₙ gates that provide reasonably short solutions to the problem with much smaller consumption of classical resources (primarily CPU time).

The method has several meta-parameters that allow for trade-offs between CPU time, memory consumption and solution quality (computed as number of CX gates in the resulting circuit). The meta-parameters will be introduced in the description, when they are relevant.

Consider a solution “pool”, which in the beginning contains a single circuit—the empty circuit. The pool size during the method execution is bounded from top by a meta parameter MAX_POOL_SIZE. We then execute the following routine (1), until at least one element of the pool solves the required variant.

Routine (1): create a new solution pool, “pool2”. For each element of the pool, copy the circuit relevant number of times and append to each a different allowed CX gate. Add each of those new circuits to pool2. We introduce a meta parameter POOL_SIZE_MULT. There are two possibilities:

After addition of the new circuit, size of pool2 is less than POOL_SIZE_MULT*

MAX_POOL_SIZE. We simply proceed to the next circuit.

The size of pool2 is equal to POOL_SIZE_MULT*MAX_POOL_SIZE. We then remove a random element from pool2 before adding the new circuit. The removed element should be randomly selected among those with the worst score (scoring strategies are discussed below).

After executing routine (1) until pool is empty, we remove duplicate circuits from pool2. This motivates POOL_SIZE_MULT parameter—we allow for more elements in pool2 during execution of routine (1), so that after duplicates removal size of pool2 is roughly equal to MAX_POOL_SIZE. If, after this deduplication, the size of pool2 still exceeds MAX_POOL_SIZE, we again remove random worst-scoring elements of the pool, until the size of pool2 becomes MAX_POOL_SIZE. Finally, we substitute pool:=pool2 for the next iteration.

For efficient implementation, we use non-volatile, hard drive memory. Instead of remembering the whole circuit, we only remember the current and enumerated wire signatures in the pool. We save those to the hard drive after assignment pool:=pool2. We will then be able to reconstruct the circuit based on the saved files and backtracking the wire signatures from the final one, by enumerating possible CX gates that enabled the step. In this way, each element of the pool can be stored using less memory (than would be needed for a full circuit).

The pools should be implemented using contiguous segments of memory to enhance CPUcache usage. Practical values of the meta-parameters are as follows:

| | Reasonable | |
|---|---|---|
| Name | Value | Main trade-off |
| MAX_POOL_SIZE | 10⁷-10⁸ | Memory + Time/Solution |
| | | quality |
| POOL_SIZE_MULT | 1.5 | Memory + Time/Solution |
| | | quality |

The score function is dependent on the variant solved. The functions used are as follows:

| Variant | Score function |
|---|---|
| SPA | Number of enumerated wire signatures. |
| WPA | Number of enumerated wire signatures, if not every wire |
| | signature was enumerated. Otherwise, the number of all wire |
| | signatures + number of wires with singleton wire signatures. |
| NPA | Number of enumerated wire signatures, if not every wire |
| | signature was enumerated. Otherwise, the number of all wire |
| | signatures + number of wires with wire signatures equal to |
| | the initial wire signatures. |

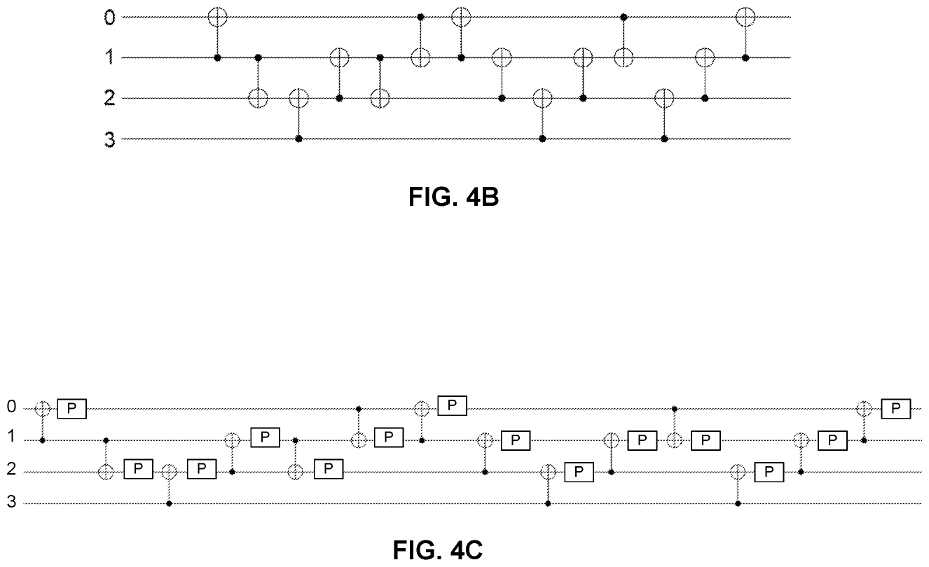

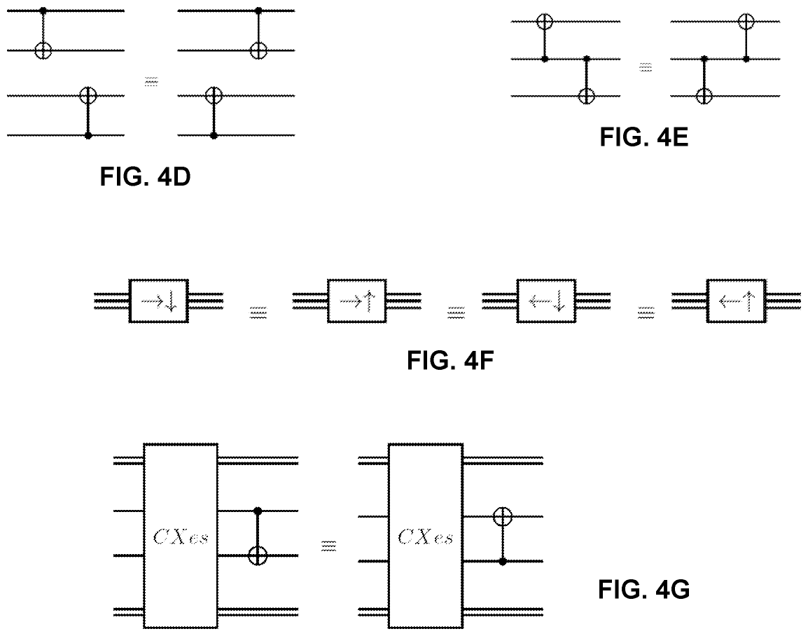

FIG. 4A is a block diagram of an example quantum computing architecture. In particular, a quantum circuit 410 is shown with an associated k-qubit quantum register 420. The quantum circuit 410 includes one or more TDGₙ gates 412 (where n is less than or equal to k), one or more diffusion (G) gates 114 and/or one or more other quantum logic gates 416.

The other quantum logic gates 116, when present, can further include Hadamard (H) gates, X gates, Y gates, Z gates, phase shift gates, controlled gates, such as CX, CY and/or CZ gates, swap gates, Toffoli gates, Deutsch gates, Ising gates, Fredkin gates, Adalus gates and/or other quantum logic gates and combinations thereof in various circuit configurations. In operation, the quantum circuit 410 generates a quantum computing result based on a measurement from the k of qubits—with or without the use of additional (ancillary or ancilla) working qubits.

In various examples, the various gates the quantum circuit 410 can be implemented with one or more processing devices. Each such processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. Each such processing device can operate in conjunction with an attached memory and/or an integrated memory element such as classical memory or other memory device, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information.

Note that if the quantum circuit 410 is implemented via more than one processing device, the processing devices may be centrally located (e.g., directly coupled together via a wired and/or wireless bus structure) or may be distributedly located (e.g., cloud computing via indirect coupling via a local area network and/or a wide area network). Further note that if the quantum circuit 410 implements one or more of its gates or other functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, a memory can store, and a processing device can execute, hard coded and/or other operational instructions corresponding to at least some of the steps and/or functions illustrated in one or more of the Figures. Such a memory device or memory element can be tangible memory device or other non-transitory storage medium included in or implemented as an article of manufacture.

FIGS. 4B-4C are schematic/block diagrams of example quantum circuits. These examples can be used to illustrate a nomenclature for describing the particular sequence of CX gates on n wires for TDGₙ gates 412. As used herein TDG₄ refers to any one of the possible TDGₙ gates 412, where n=4. A prepending designation “NPA-”, or “SPA-” refers to the corresponding variant.

FIG. 4B presents the sequence of 14 CX gates on 4 wires corresponding to the first SPA-TDG₄ gate, (SPA-TDG₄₋₁). Each CX gate in the sequence can be described by a number pair (a, b) where b represents the number of the wire to be controlled and a represents the number of the controlling wire. In this fashion, the first CX gate in the sequence (left to right) is (1, 0), the second CX gate is (1, 2). Using this convention, the unique sequence of CXs in the SPA-TDG₄₋₁ gate can be described as:

(1, 0) (1, 2) (3, 2) (2, 1) (1, 2) (0, 1) (1, 0) (2, 1) (3, 2) (2, 1) (0, 1) (3, 2) (2, 1) (1, 0)
Adding the phase gates (P) to correspond to each of the CX gates in this sequence results in the SPA-TDG₄₋₁ gate shown in FIG. 4C.

FIGS. 4D-4G are schematic/block diagrams of example equivalency rules. Sets of the TDG₄ gates and TDG₅ gates can be generated based on solutions found using the heuristic TDG sequence generation process previously described along with the application of different equivalency rules. In FIG. 4D, the order of two subsequent CX gates with disjoint sets of operating qubits is irrelevant for correct enumeration of state subsets. This rule may be applied without regard to orientation of CX in question. In FIG. 4E, the order of two subsequent CX gates sharing a control qubit is irrelevant for correct enumeration of state subsets. In FIG. 4F, the whole circuit may be reversed and the whole circuit may be applied to the reversed order of the wires without affecting the correctness of the solution. In FIG. 4G, in the case of SPA circuits, direction of the last CX in the circuit does not matter for solution correctness. This rule, together with the previous rule of FIG. 4F, means that the direction of the first CX in the circuit may be changed freely as well.

In various examples, the equivalency rules can be applied until the lexicographically smallest equivalent solution is obtained. The solution is lexicographically smaller, if its transcription into a list of pairs treated as a string is lexicographically smaller. These solutions (called normalized solutions) are then sorted lexicographically and any duplicates are removed. To check whether a solution is equivalent to one of the listed solutions, one can simply compute the corresponding normalized solution and check its presence on the lists provided below.

A full set of CX sequences for all NPA-TDG₄ gates is shown below:

SPA-TDG₄₋₁: (1, 0) (1, 2) (3, 2) (2, 1) (1, 2) (0, 1) (1, 0) (2, 1) (3, 2) (2, 1) (0, 1) (3, 2) (2, 1) (1, 0)

SPA-TDG₄₋₂: (1, 0) (1, 2) (3, 2) (2, 1) (1, 2) (0, 1) (1, 0) (2, 1) (3, 2) (2, 1) (3, 2) (2, 1) (0, 1) (2, 1)

SPA-TDG₄₋₃: (1, 0) (1, 2) (3, 2) (2, 1) (1, 2) (0, 1) (2, 1) (1, 0) (3, 2) (2, 1) (0, 1) (3, 2) (2, 1) (1, 0)

SPA-TDG₄₋₄: (1, 0) (1, 2) (3, 2) (2, 1) (1, 2) (0, 1) (2, 1) (1, 0) (3, 2) (2, 1) (3, 2) (2, 1) (0, 1) (2, 1)

SPA-TDG₄₋₅: (1, 0) (1, 2) (3, 2) (2, 1) (1, 2) (0, 1) (2, 1) (3, 2) (2, 3) (1, 2) (0, 1) (1, 2) (3, 2) (2, 1)

SPA-TDG₄₋₆: (1, 0) (1, 2) (3, 2) (2, 1) (1, 2) (0, 1) (2, 1) (3, 2) (2, 3) (1, 2) (0, 1) (3, 2) (1, 2) (3, 2)

SPA-TDG₄₋₇: (1, 0) (2, 1) (0, 1) (3, 2) (2, 1) (0, 1) (3, 2) (2, 1) (1, 0) (0, 1) (1, 2) (2, 1) (3, 2) (2, 1)

SPA-TDG₄₋₈: (1, 0) (2, 1) (0, 1) (3, 2) (2, 1) (0, 1) (3, 2) (2, 1) (1, 0) (0, 1) (1, 2) (2, 3) (1, 2) (3, 2)

SPA-TDG₄₋₉: (1, 0) (2, 1) (0, 1) (3, 2) (2, 1) (0, 1) (3, 2) (2, 1) (1, 0) (0, 1) (1, 2) (2, 3) (3, 2) (2, 1)

SPA-TDG₄₋₁₀: (1, 0) (2, 1) (0, 1) (3, 2) (2, 1) (1, 0) (0, 1) (1, 2) (3, 2) (2, 1) (1, 2) (0, 1) (2, 3) (2, 1)

SPA-TDG₄₋₁₁: (1, 0) (2, 1) (0, 1) (3, 2) (2, 1) (1, 0) (3, 2) (2, 1) (0, 1) (1, 2) (2, 1) (1, 0) (3, 2) (2, 1)

SPA-TDG₄₋₁₂: (1, 0) (2, 1) (0, 1) (3, 2) (2, 1) (3, 2) (2, 1) (1, 0) (0, 1) (1, 2) (2, 1) (1, 0) (3, 2) (2, 1)

SPA-TDG₄₋₁₃: (1, 0) (2, 1) (1, 0) (0, 1) (3, 2) (1, 2) (0, 1) (2, 3) (1, 2) (0, 1) (1, 2) (3, 2) (2, 1) (1, 0)

SPA-TDG₄₋₁₄: (1, 0) (2, 1) (1, 0) (2, 1) (3, 2) (1, 2) (0, 1) (2, 3) (1, 2) (0, 1) (1, 2) (3, 2) (2, 1) (1, 0)

SPA-TDG₄₋₁₅: (1, 0) (2, 1) (1, 0) (2, 1) (3, 2) (2, 3) (1, 2) (0, 1) (3, 2) (1, 2) (0, 1) (1, 2) (3, 2) (2, 1)

SPA-TDG₄₋₁₆: (1, 0) (2, 1) (1, 0) (3, 2) (2, 1) (0, 1) (1, 2) (2, 1) (1, 0) (3, 2) (2, 1) (0, 1) (1, 2) (3, 2)

SPA-TDG₄₋₁₇: (1, 0) (2, 1) (1, 0) (3, 2) (2, 1) (0, 1) (1, 2) (2, 1) (1, 0) (3, 2) (2, 1) (0, 1) (3, 2) (2, 1)

SPA-TDG₄₋₁₈: (1, 0) (2, 1) (1, 0) (3, 2) (2, 1) (0, 1) (1, 2) (2, 1) (3, 2) (2, 3) (1, 2) (0, 1) (1, 2) (3, 2)

SPA-TDG₄₋₁₉: (1, 0) (2, 1) (1, 0) (3, 2) (2, 1) (0, 1) (2, 3) (1, 2) (2, 1) (3, 2) (2, 1) (0, 1) (1, 2) (3, 2)

SPA-TDG₄₋₂₀: (1, 0) (2, 1) (1, 0) (3, 2) (2, 1) (0, 1) (3, 2) (2, 1) (1, 0) (3, 2) (2, 1) (0, 1) (1, 2) (3, 2)

SPA-TDG₄₋₂₁: (1, 0) (2, 1) (1, 0) (3, 2) (2, 1) (0, 1) (3, 2) (2, 1) (1, 0) (3, 2) (2, 1) (0, 1) (3, 2) (2, 1)

SPA-TDG₄₋₂₂: (1, 0) (2, 1) (1, 0) (3, 2) (2, 1) (0, 1) (3, 2) (2, 1) (3, 2) (2, 3) (1, 2) (0, 1) (1, 2) (3, 2)

SPA-TDG₄₋₂₃: (1, 0) (2, 1) (1, 0) (3, 2) (2, 1) (1, 2) (0, 1) (1, 0) (2, 1) (3, 2) (2, 1) (0, 1) (1, 2) (3, 2)

SPA-TDG₄₋₂₄: (1, 0) (2, 1) (1, 0) (3, 2) (2, 1) (1, 2) (0, 1) (1, 0) (2, 1) (3, 2) (2, 1) (0, 1) (3, 2) (2, 1)

SPA-TDG₄₋₂₅: (1, 0) (2, 1) (1, 0) (3, 2) (2, 1) (1, 2) (0, 1) (2, 1) (1, 0) (3, 2) (2, 1) (0, 1) (1, 2) (3, 2)

SPA-TDG₄₋₂₆: (1, 0) (2, 1) (1, 0) (3, 2) (2, 1) (1, 2) (0, 1) (2, 1) (1, 0) (3, 2) (2, 1) (0, 1) (3, 2) (2, 1)

SPA-TDG₄₋₂₇: (1, 0) (2, 1) (1, 0) (3, 2) (2, 1) (1, 2) (0, 1) (2, 1) (3, 2) (2, 3) (1, 2) (0, 1) (1, 2) (3, 2)

SPA-TDG₄₋₂₈: (1, 0) (2, 1) (1, 2) (0, 1) (3, 2) (1, 2) (0, 1) (2, 3) (1, 2) (0, 1) (1, 2) (3, 2) (2, 1) (1, 0)

SPA-TDG₄₋₂₉: (1, 0) (2, 1) (1, 2) (3, 2) (2, 1) (0, 1) (1, 2) (2, 1) (1, 0) (3, 2) (2, 1) (0, 1) (1, 2) (3, 2)

SPA-TDG₄₋₃₀: (1, 0) (2, 1) (1, 2) (3, 2) (2, 1) (0, 1) (1, 2) (2, 1) (1, 0) (3, 2) (2, 1) (0, 1) (3, 2) (2, 1)

SPA-TDG₄₋₃₁: (1, 0) (2, 1) (1, 2) (3, 2) (2, 1) (0, 1) (1, 2) (2, 1) (3, 2) (2, 3) (1, 2) (0, 1) (1, 2) (3, 2)

SPA-TDG₄₋₃₂: (1, 0) (2, 1) (1, 2) (3, 2) (2, 1) (0, 1) (2, 3) (1, 2) (2, 1) (3, 2) (2, 1) (0, 1) (1, 2) (3, 2)

SPA-TDG₄₋₃₃: (1, 0) (2, 1) (1, 2) (3, 2) (2, 1) (1, 2) (0, 1) (1, 0) (2, 1) (3, 2) (2, 1) (0, 1) (1, 2) (3, 2)

SPA-TDG₄₋₃₄: (1, 0) (2, 1) (3, 2) (1, 2) (0, 1) (1, 0) (1, 2) (2, 3) (1, 2) (0, 1) (1, 2) (3, 2) (2, 1) (1, 0)

SPA-TDG₄₋₃₅: (1, 0) (2, 1) (3, 2) (1, 2) (0, 1) (1, 0) (1, 2) (2, 3) (3, 2) (2, 1) (1, 0) (0, 1) (1, 2) (3, 2)

SPA-TDG₄₋₃₆: (1, 0) (2, 1) (3, 2) (1, 2) (0, 1) (1, 0) (1, 2) (2, 3) (3, 2) (2, 1) (1, 2) (0, 1) (1, 2) (3, 2)

SPA-TDG₄₋₃₇: (1, 0) (2, 1) (3, 2) (1, 2) (0, 1) (1, 2) (0, 1) (2, 3) (1, 2) (0, 1) (1, 2) (3, 2) (2, 1) (1, 0)

SPA-TDG₄₋₃₈: (1, 0) (2, 1) (3, 2) (1, 2) (0, 1) (1, 2) (0, 1) (2, 3) (1, 2) (0, 1) (3, 2) (1, 2) (0, 1) (2, 1)

SPA-TDG₄₋₃₉: (1, 0) (2, 1) (3, 2) (1, 2) (0, 1) (1, 2) (0, 1) (2, 3) (1, 2) (3, 2) (2, 1) (1, 0) (0, 1) (2, 1)

SPA-TDG₄₋₄₀: (1, 0) (2, 1) (3, 2) (1, 2) (0, 1) (1, 2) (0, 1) (2, 3) (1, 2) (3, 2) (2, 1) (1, 2) (0, 1) (2, 1)

SPA-TDG₄₋₄₁: (1, 0) (2, 1) (3, 2) (1, 2) (0, 1) (1, 2) (2, 1) (1, 0) (1, 2) (3, 2) (2, 1) (0, 1) (1, 2) (3, 2)

SPA-TDG₄₋₄₂: (1, 0) (2, 1) (3, 2) (1, 2) (0, 1) (1, 2) (2, 1) (1, 0) (1, 2) (3, 2) (2, 1) (0, 1) (3, 2) (2, 1)

SPA-TDG₄₋₄₃: (1, 0) (2, 1) (3, 2) (1, 2) (0, 1) (1, 2) (2, 1) (1, 0) (3, 2) (1, 2) (0, 1) (2, 1) (3, 2) (2, 1)

SPA-TDG₄₋₄₄: (1, 0) (2, 1) (3, 2) (1, 2) (0, 1) (1, 2) (2, 1) (1, 0) (3, 2) (1, 2) (2, 1) (0, 1) (1, 2) (3, 2)

SPA-TDG₄₋₄₅: (1, 0) (2, 1) (3, 2) (1, 2) (0, 1) (1, 2) (2, 1) (1, 0) (3, 2) (1, 2) (2, 1) (0, 1) (3, 2) (2, 1)

SPA-TDG₄₋₄₆: (1, 0) (2, 1) (3, 2) (1, 2) (0, 1) (1, 2) (2, 1) (1, 2) (3, 2) (2, 3) (1, 2) (0, 1) (1, 2) (3, 2)

SPA-TDG₄₋₄₇: (1, 0) (2, 1) (3, 2) (1, 2) (0, 1) (1, 2) (2, 1) (3, 2) (1, 2) (2, 3) (1, 2) (0, 1) (1, 2) (3, 2)

SPA-TDG₄₋₄₈: (1, 0) (2, 1) (3, 2) (1, 2) (0, 1) (1, 2) (2, 3) (1, 2) (0, 1) (3, 2) (1, 2) (0, 1) (1, 2) (3, 2)

SPA-TDG₄₋₄₉: (1, 0) (2, 1) (3, 2) (1, 2) (0, 1) (1, 2) (2, 3) (1, 2) (3, 2) (2, 1) (1, 0) (0, 1) (1, 2) (3, 2)

SPA-TDG₄₋₅₀: (1, 0) (2, 1) (3, 2) (1, 2) (0, 1) (1, 2) (2, 3) (1, 2) (3, 2) (2, 1) (1, 2) (0, 1) (1, 2) (3, 2)

SPA-TDG₄₋₅₁: (1, 0) (2, 1) (3, 2) (1, 2) (0, 1) (1, 2) (2, 3) (3, 2) (1, 2) (0, 1) (1, 2) (0, 1) (1, 2) (3, 2)

SPA-TDG₄₋₅₂: (1, 0) (2, 1) (3, 2) (1, 2) (0, 1) (1, 2) (2, 3) (3, 2) (1, 2) (2, 1) (1, 0) (0, 1) (1, 2) (3, 2)

SPA-TDG₄₋₅₃: (1, 0) (2, 1) (3, 2) (1, 2) (0, 1) (1, 2) (2, 3) (3, 2) (1, 2) (2, 1) (1, 2) (0, 1) (1, 2) (3, 2)

SPA-TDG₄₋₅₄: (1, 0) (2, 1) (3, 2) (1, 2) (0, 1) (1, 2) (2, 3) (3, 2) (2, 1) (1, 2) (0, 1) (2, 1) (3, 2) (2, 1)

SPA-TDG₄₋₅₅: (1, 0) (2, 1) (3, 2) (1, 2) (0, 1) (1, 2) (2, 3) (3, 2) (2, 1) (1, 2) (2, 1) (0, 1) (1, 2) (3, 2)

SPA-TDG₄₋₅₆: (1, 0) (2, 1) (3, 2) (1, 2) (0, 1) (2, 1) (1, 2) (2, 1) (1, 0) (3, 2) (2, 1) (0, 1) (1, 2) (3, 2)

SPA-TDG₄₋₅₇: (1, 0) (2, 1) (3, 2) (1, 2) (0, 1) (2, 1) (1, 2) (2, 1) (1, 0) (3, 2) (2, 1) (0, 1) (3, 2) (2, 1)

SPA-TDG₄₋₅₈: (1, 0) (2, 1) (3, 2) (1, 2) (0, 1) (2, 1) (1, 2) (2, 1) (3, 2) (2, 3) (1, 2) (0, 1) (1, 2) (3, 2)

SPA-TDG₄₋₅₉: (1, 0) (2, 1) (3, 2) (1, 2) (0, 1) (2, 1) (3, 2) (2, 1) (1, 0) (3, 2) (2, 1) (0, 1) (1, 2) (3, 2)

SPA-TDG₄₋₆₀: (1, 0) (2, 1) (3, 2) (1, 2) (0, 1) (2, 1) (3, 2) (2, 1) (1, 0) (3, 2) (2, 1) (0, 1) (3, 2) (2, 1)

SPA-TDG₄₋₆₁: (1, 0) (2, 1) (3, 2) (1, 2) (0, 1) (2, 1) (3, 2) (2, 1) (3, 2) (2, 3) (1, 2) (0, 1) (1, 2) (3, 2)

SPA-TDG₄₋₆₂: (1, 0) (2, 1) (3, 2) (1, 2) (0, 1) (2, 3) (1, 2) (0, 1) (1, 2) (3, 2) (2, 1) (0, 1) (3, 2) (2, 1)

SPA-TDG₄₋₆₃: (1, 0) (2, 1) (3, 2) (1, 2) (0, 1) (2, 3) (1, 2) (0, 1) (3, 2) (1, 2) (0, 1) (2, 1) (3, 2) (2, 1)

SPA-TDG₄₋₆₄: (1, 0) (2, 1) (3, 2) (1, 2) (0, 1) (2, 3) (1, 2) (0, 1) (3, 2) (1, 2) (2, 1) (0, 1) (3, 2) (2, 1)

SPA-TDG₄₋₆₅: (1, 0) (2, 1) (3, 2) (1, 2) (0, 1) (2, 3) (1, 2) (2, 1) (3, 2) (1, 2) (0, 1) (2, 1) (3, 2) (2, 1)

SPA-TDG₄₋₆₆: (1, 0) (2, 1) (3, 2) (1, 2) (0, 1) (2, 3) (1, 2) (2, 1) (3, 2) (1, 2) (2, 1) (0, 1) (1, 2) (3, 2)

SPA-TDG₄₋₆₇: (1, 0) (2, 1) (3, 2) (1, 2) (0, 1) (2, 3) (1, 2) (3, 2) (2, 1) (1, 2) (0, 1) (2, 1) (3, 2) (2, 1)

SPA-TDG₄₋₆₈: (1, 0) (2, 1) (3, 2) (1, 2) (2, 1) (0, 1) (1, 2) (2, 1) (1, 0) (3, 2) (2, 1) (0, 1) (3, 2) (2, 1)

SPA-TDG₄₋₆₉: (1, 0) (2, 1) (3, 2) (1, 2) (2, 1) (0, 1) (1, 2) (2, 1) (3, 2) (2, 3) (1, 2) (0, 1) (1, 2) (3, 2)

SPA-TDG₄₋₇₀: (1, 0) (2, 1) (3, 2) (2, 1) (0, 1) (3, 2) (2, 1) (1, 0) (0, 1) (1, 2) (2, 1) (3, 2) (2, 1) (1, 0)

SPA-TDG₄₋₇₁: (1, 0) (2, 1) (3, 2) (2, 1) (0, 1) (3, 2) (2, 1) (1, 0) (0, 1) (1, 2) (2, 3) (3, 2) (2, 1) (1, 0)

SPA-TDG₄₋₇₂: (1, 0) (2, 1) (3, 2) (2, 1) (1, 0) (0, 1) (1, 2) (0, 1) (1, 2) (3, 2) (2, 1) (0, 1) (3, 2) (2, 1)

SPA-TDG₄₋₇₃: (1, 0) (2, 1) (3, 2) (2, 1) (1, 0) (0, 1) (1, 2) (0, 1) (3, 2) (1, 2) (0, 1) (2, 1) (3, 2) (2, 1)

SPA-TDG₄₋₇₄: (1, 0) (2, 1) (3, 2) (2, 1) (1, 0) (0, 1) (1, 2) (0, 1) (3, 2) (1, 2) (2, 1) (0, 1) (3, 2) (2, 1)

SPA-TDG₄₋₇₅: (1, 0) (2, 1) (3, 2) (2, 1) (1, 0) (0, 1) (1, 2) (2, 1) (3, 2) (1, 2) (0, 1) (2, 1) (3, 2) (2, 1)

SPA-TDG₄₋₇₆: (1, 0) (2, 1) (3, 2) (2, 1) (1, 0) (0, 1) (1, 2) (3, 2) (2, 1) (1, 2) (0, 1) (2, 1) (3, 2) (2, 1)

SPA-TDG₄₋₇₇: (2, 1) (0, 1) (1, 0) (2, 1) (3, 2) (2, 3) (1, 2) (0, 1) (3, 2) (1, 2) (0, 1) (1, 2) (3, 2) (2, 1)

SPA-TDG₄₋₇₈: (2, 1) (0, 1) (1, 2) (2, 1) (3, 2) (2, 3) (1, 2) (0, 1) (3, 2) (1, 2) (0, 1) (1, 2) (3, 2) (2, 1)

SPA-TDG₄₋₇₉: (2, 1) (0, 1) (1, 2) (3, 2) (2, 1) (0, 1) (1, 2) (2, 1) (1, 0) (3, 2) (2, 1) (0, 1) (3, 2) (2, 1)

SPA-TDG₄₋₈₀: (2, 1) (0, 1) (1, 2) (3, 2) (2, 1) (0, 1) (3, 2) (2, 1) (1, 0) (3, 2) (2, 1) (0, 1) (3, 2) (2, 1)

SPA-TDG₄₋₈₁: (2, 1) (0, 1) (1, 2) (3, 2) (2, 1) (1, 2) (0, 1) (1, 0) (2, 1) (3, 2) (2, 1) (0, 1) (3, 2) (2, 1)

SPA-TDG₄₋₈₂: (2, 1) (0, 1) (1, 2) (3, 2) (2, 1) (1, 2) (0, 1) (2, 1) (1, 0) (3, 2) (2, 1) (0, 1) (3, 2) (2, 1)

SPA-TDG₄₋₈₃: (2, 1) (0, 1) (2, 1) (3, 2) (2, 1) (1, 0) (0, 1) (1, 2) (3, 2) (2, 1) (1, 2) (0, 1) (2, 3) (2, 1)

SPA-TDG₄₋₈₄: (2, 1) (0, 1) (2, 1) (3, 2) (2, 1) (1, 0) (3, 2) (2, 1) (0, 1) (1, 2) (2, 1) (1, 0) (3, 2) (2, 1)

SPA-TDG₄₋₈₅: (2, 1) (0, 1) (2, 1) (3, 2) (2, 1) (3, 2) (2, 1) (1, 0) (0, 1) (1, 2) (2, 1) (1, 0) (3, 2) (2, 1)

SPA-TDG₄₋₈₆: (2, 1) (0, 1) (3, 2) (1, 2) (0, 1) (2, 1) (3, 2) (2, 1) (1, 0) (3, 2) (2, 1) (0, 1) (3, 2) (2, 1)

In a similar fashion to FIG. 4C, adding the phase gates (P) to follow each of the CX gates in the sequences above results in the circuits corresponding to the SPA-TDG₄₋ᵢ gates, i=1, 2, . . . 86.

A full set of CX sequences for all NPA-TDG₄ gates is shown below:
NPA-TDG₄₋₁: (0, 1) (1, 2) (0, 1) (2, 3) (1, 2) (0, 1) (3, 2) (1, 2) (0, 1) (2, 3) (1, 2) (0, 1) (3, 2) (1, 2) (0, 1) (2, 3) (1, 2) (3, 2)
NPA-TDG₄₋₂: (0, 1) (1, 2) (0, 1) (3, 2) (1, 2) (0, 1) (2, 3) (1, 2) (0, 1) (3, 2) (1, 2) (0, 1) (2, 3) (1, 2) (0, 1) (3, 2) (1, 2) (2, 3)
NPA-TDG₄₋₃: (0, 1) (2, 3) (1, 2) (0, 1) (3, 2) (1, 2) (0, 1) (2, 3) (1, 2) (0, 1) (3, 2) (1, 2) (0, 1) (2, 3) (1, 2) (0, 1) (3, 2) (1, 2)
SPA-TDG₄₋₄: (0, 1) (3, 2) (1, 2) (0, 1) (2, 3) (1, 2) (0, 1) (3, 2) (1, 2) (0, 1) (2, 3) (1, 2) (0, 1) (3, 2) (1, 2) (0, 1) (2, 3) (1, 2)
   In a similar fashion to FIG. 4C, adding the phase gates (P) to follow each of the CX gates in the sequences above results in the circuits corresponding to the NPA-TDG₄₋ᵢ gates, i=1, 2, . . . 4.

A full set of CX sequences for all SPA-TDG₅ gates is shown below:
SPA-TDG₅₋₁: (1, 0) (2, 1) (3, 2) (1, 2) (4, 3) (3, 2) (2, 1) (0, 1) (1, 2) (2, 1) (3, 2) (2, 3) (1, 2) (0, 1) (4, 3) (3, 2) (1, 2) (0, 1) (3, 4) (2, 3) (1, 2) (3, 2) (4, 3) (3, 2) (2, 1) (1, 2) (0, 1) (2, 3) (1, 2) (2, 3) (4, 3)
SPA-TDG₅₋₂: (1, 0) (2, 1) (3, 2) (1, 2) (4, 3) (3, 2) (2, 1) (0, 1) (1, 2) (2, 1) (3, 2) (4, 3) (2, 3) (1, 2) (0, 1) (3, 2) (1, 2) (0, 1) (3, 4) (2, 3) (1, 2) (3, 2) (4, 3) (3, 2) (2, 1) (1, 2) (0, 1) (2, 3) (1, 2) (2, 3) (4, 3)
SPA-TDG₅₋₂: (1, 0) (2, 1) (3, 2) (2, 1) (4, 3) (3, 2) (2, 3) (1, 2) (0, 1) (1, 2) (3, 2) (2, 1) (1, 0) (1, 2) (4, 3) (3, 2) (2, 1) (0, 1) (4, 3) (3, 2) (1, 2) (2, 3) (3, 2) (2, 1) (4, 3) (3, 2) (1, 2) (0, 1) (1, 2) (2, 3) (4, 3)
SPA-TDG₅₋₃: (1, 0) (2, 1) (3, 2) (2, 1) (4, 3) (3, 2) (2, 3) (1, 2) (0, 1) (1, 2) (3, 2) (2, 1) (1, 0) (4, 3) (3, 2) (1, 2) (0, 1) (2, 1) (4, 3) (3, 2) (1, 2) (2, 3) (3, 2) (2, 1) (4, 3) (3, 2) (1, 2) (0, 1) (1, 2) (2, 3) (4, 3)
SPA-TDG₅₋₄: (1, 0) (2, 1) (3, 2) (2, 1) (4, 3) (3, 2) (2, 3) (1, 2) (0, 1) (1, 2) (3, 2) (2, 1) (1, 0) (4, 3) (3, 2) (1, 2) (2, 1) (0, 1) (4, 3) (3, 2) (1, 2) (2, 3) (3, 2) (2, 1) (4, 3) (3, 2) (1, 2) (0, 1) (1, 2) (2, 3) (4, 3)
SPA-TDG₅₋₅: (2, 1) (0, 1) (3, 2) (2, 1) (1, 0) (4, 3) (3, 2) (2, 3) (1, 2) (0, 1) (2, 1) (1, 0) (3, 2) (1, 2) (4, 3) (3, 2) (2, 1) (4, 3) (3, 2) (1, 2) (0, 1) (1, 2) (2, 3) (3, 2) (2, 1) (4, 3) (3, 2) (2, 1) (0, 1) (1, 2) (3, 2)
SPA-TDG₅₋₆: (2, 1) (0, 1) (3, 2) (2, 1) (1, 0) (4, 3) (3, 2) (2, 3) (1, 2) (2, 1) (0, 1) (1, 0) (3, 2) (1, 2) (4, 3) (3, 2) (2, 1) (4, 3) (3, 2) (1, 2) (0, 1) (1, 2) (2, 3) (3, 2) (2, 1) (4, 3) (3, 2) (2, 1) (0, 1) (1, 2) (3, 2)
SPA-TDG₅₋₇: (2, 1) (3, 2) (4, 3) (2, 3) (1, 2) (0, 1) (2, 3) (1, 2) (2, 1) (3, 2) (4, 3) (3, 2) (1, 2) (0, 1) (2, 3) (1, 2) (0, 1) (3, 2) (1, 2) (3, 4) (2, 3) (4, 3) (3, 2) (2, 1) (1, 2) (0, 1) (2, 1) (3, 2) (4, 3) (3, 2) (2, 1)
SPA-TDG₅₋₈: (2, 1) (3, 2) (4, 3) (2, 3) (1, 2) (0, 1) (2, 3) (1, 2) (2, 1) (3, 2) (4, 3) (3, 2) (1, 2) (0, 1) (2, 3) (1, 2) (0, 1) (3, 2) (1, 2) (3, 4) (4, 3) (2, 3) (3, 2) (2, 1) (1, 2) (0, 1) (2, 1) (3, 2) (4, 3) (3, 2) (2, 1)
   In a similar fashion to FIG. 4C, adding the phase gates (P) to follow each of the CX gates in the sequences above results in the circuits corresponding to the SPA-TDG₅₋ᵢ gates, i=1, 2, . . . 8.

A full set of CX sequences for all NPA-TDG₅ gates is shown below:
NPA-TDG₅₋₁: (0, 1) (1, 0) (1, 2) (2, 3) (3, 2) (2, 1) (0, 1) (4, 3) (3, 2) (2, 1) (1, 0) (3, 2) (4, 3) (3, 2) (2, 3) (1, 2) (2, 1) (3, 2) (1, 2) (0, 1) (1, 0) (1, 2) (2, 3) (3, 2) (2, 1) (4, 3) (3, 2) (2, 3) (1, 2) (0, 1) (1, 2) (3, 2) (2, 1) (1, 0) (4, 3) (3, 2) (1, 2) (4, 3) (3, 2) (2, 1)
NPA-TDG₅₋₂: (0, 1) (1, 0) (1, 2) (2, 3) (3, 2) (2, 1) (4, 3) (3, 2) (2, 3) (1, 2) (0, 1) (1, 2) (3, 2) (2, 1) (1, 0) (4, 3) (3, 2) (1, 2) (0, 1) (4, 3) (3, 2) (2, 1) (1, 0) (1, 2) (2, 3) (3, 2) (2, 1) (0, 1) (4, 3) (3, 2) (2, 1) (1, 0) (3, 2) (4, 3) (3, 2) (2, 3) (1, 2) (2, 1) (3, 2) (1, 2)
NPA-TDG₅₋₃: (0, 1) (1, 0) (1, 2) (2, 3) (3, 2) (2, 1) (4, 3) (3, 2) (2, 3) (1, 2) (0, 1) (1, 2) (3, 2) (2, 1) (1, 0) (4, 3) (3, 2) (1, 2) (4, 3) (3, 2) (2, 1) (0, 1) (1, 0) (1, 2) (2, 3) (3, 2) (2, 1) (0, 1) (4, 3) (3, 2) (2, 1) (1, 0) (3, 2) (4, 3) (3, 2) (2, 3) (1, 2) (2, 1) (3, 2) (1, 2)
NPA-TDG₅₋₄: (0, 1) (1, 0) (1, 2) (3, 2) (2, 1) (4, 3) (3, 2) (1, 2) (0, 1) (1, 2) (2, 3) (3, 2) (2, 1) (1, 0) (4, 3) (3, 2) (2, 3) (1, 2) (0, 1) (1, 2) (3, 2) (2, 1) (1, 0) (1, 2) (2, 3) (3, 2) (4, 3) (3, 2) (2, 1) (0, 1) (3, 2) (2, 1) (1, 0) (4, 3) (3, 2) (2, 3) (1, 2) (2, 1) (3, 2) (4, 3)
NPA-TDG₅₋₅: (0, 1) (1, 0) (1, 2) (4, 3) (3, 2) (2, 1) (4, 3) (3, 2) (1, 2) (0, 1) (1, 2) (2, 3) (3, 2) (2, 1) (1, 0) (4, 3) (3, 2) (2, 3) (1, 2) (0, 1) (1, 2) (3, 2) (2, 1) (1, 0) (1, 2) (2, 3) (3, 2) (4, 3) (3, 2) (2, 1) (0, 1) (3, 2) (2, 1) (1, 0) (4, 3) (3, 2) (2, 3) (1, 2) (2, 1) (3, 2)
NPA-TDG₅₋₆: (0, 1) (1, 0) (3, 2) (1, 2) (4, 3) (3, 2) (2, 1) (4, 3) (3, 2) (1, 2) (0, 1) (1, 2) (2, 3) (3, 2) (2, 1) (1, 0) (4, 3) (3, 2) (2, 3) (1, 2) (0, 1) (1, 2) (3, 2) (2, 1) (1, 0) (1, 2) (2, 3) (3, 2) (4, 3) (3, 2) (2, 1) (0, 1) (3, 2) (2, 1) (1, 0) (4, 3) (3, 2) (2, 3) (1, 2) (2, 1)
NPA-TDG₅₋₇: (0, 1) (1, 2) (0, 1) (2, 3) (1, 2) (3, 2) (4, 3) (3, 2) (2, 1) (1, 2) (0, 1) (2, 3) (1, 2) (2, 1) (3, 2) (3, 4) (4, 3) (3, 2) (1, 2) (2, 3) (3, 2) (2, 1) (1, 2) (0, 1) (1, 2) (3, 4) (2, 3) (1, 2) (0, 1) (4, 3) (2, 3) (1, 2) (2, 1) (3, 2) (3, 4) (2, 3) (1, 2) (4, 3) (3, 2) (3, 4)
NPA-TDG₅₋₈: (0, 1) (1, 2) (0, 1) (2, 3) (1, 2) (3, 2) (4, 3) (3, 2) (2, 1) (1, 2) (0, 1) (2, 3) (1, 2) (2, 1) (3, 2) (3, 4) (4, 3) (3, 2) (1, 2) (2, 3) (3, 2) (2, 1) (1, 2) (0, 1) (1, 2) (3, 4) (2, 3) (1, 2) (0, 1) (4, 3) (2, 3) (1, 2) (2, 1) (3, 2) (3, 4) (4, 3) (2, 3) (1, 2) (3, 2) (3, 4)
NPA-TDG₅₋₉: (0, 1) (1, 2) (0, 1) (3, 2) (1, 2) (2, 3) (4, 3) (3, 2) (2, 1) (1, 2) (0, 1) (3, 4) (2, 3) (1, 2) (4, 3) (2, 3) (1, 2) (0, 1) (1, 2) (2, 1) (3, 2) (3, 4) (2, 3) (1, 2) (3, 2) (4, 3) (3, 2) (2, 1) (1, 2) (0, 1) (3, 4) (2, 3) (1, 2) (2, 1) (3, 2) (4, 3) (3, 2) (1, 2) (2, 3) (3, 4)
NPA-TDG₅₋₁₀: (0, 1) (1, 2) (0, 1) (3, 2) (1, 2) (3, 4) (2, 3) (4, 3) (3, 2) (2, 1) (1, 2) (0, 1) (3, 4) (2, 3) (1, 2) (4, 3) (2, 3) (1, 2) (0, 1) (1, 2) (2, 1) (3, 2) (3, 4) (2, 3) (1, 2) (3, 2) (4, 3) (3, 2) (2, 1) (1, 2) (0, 1) (3, 4) (2, 3) (1, 2) (2, 1) (3, 2) (4, 3) (3, 2) (1, 2) (2, 3)
NPA-TDG₅₋₁₁: (0, 1) (1, 2) (0, 1) (3, 4) (2, 3) (1, 2) (3, 2) (4, 3) (3, 2) (2, 1) (1, 2) (0, 1) (2, 3) (1, 2) (2, 1) (3, 2) (3, 4) (4, 3) (3, 2) (1, 2) (2, 3) (3, 2) (2, 1) (1, 2) (0, 1) (1, 2) (3, 4) (2, 3) (1, 2) (0, 1) (4, 3) (2, 3) (1, 2) (2, 1) (3, 2) (3, 4) (2, 3) (1, 2) (4, 3) (3, 2)
NPA-TDG₅₋₁₂: (0, 1) (1, 2) (0, 1) (3, 4) (2, 3) (1, 2) (3, 2) (4, 3) (3, 2) (2, 1) (1, 2) (0, 1) (2, 3) (1, 2) (2, 1) (3, 2) (3, 4) (4, 3) (3, 2) (1, 2) (2, 3) (3, 2) (2, 1) (1, 2) (0, 1) (1, 2) (3, 4) (2, 3) (1, 2) (0, 1) (4, 3) (2, 3) (1, 2) (2, 1) (3, 2) (3, 4) (4, 3) (2, 3) (1, 2) (3, 2)
NPA-TDG₅₋₁₃: (0, 1) (1, 2) (2, 1) (3, 2) (2, 3) (1, 2) (3, 2) (4, 3) (3, 2) (2, 1) (1, 2) (0, 1) (3, 4) (2, 3) (1, 2) (2, 1) (3, 2) (4, 3) (3, 2) (1, 2) (0, 1) (2, 3) (1, 2) (0, 1) (3, 2) (1, 2) (3, 4) (2, 3) (4, 3) (3, 2) (2, 1) (1, 2) (0, 1) (3, 4) (2, 3) (1, 2) (4, 3) (2, 3) (1, 2) (3, 4)
NPA-TDG₅₋₁₄: (0, 1) (1, 2) (2, 1) (3, 2) (3, 4) (2, 3) (1, 2) (3, 2) (4, 3) (3, 2) (2, 1) (1, 2) (0, 1) (3, 4) (2, 3) (1, 2) (2, 1) (3, 2) (4, 3) (3, 2) (1, 2) (0, 1) (2, 3) (1, 2) (0, 1) (3, 2) (1, 2) (3, 4) (2, 3) (4, 3) (3, 2) (2, 1) (1, 2) (0, 1) (3, 4) (2, 3) (1, 2) (4, 3) (2, 3) (1, 2)
NPA-TDG₅₋₁₅: (0, 1) (1, 2) (2, 1) (3, 2) (3, 4) (4, 3) (2, 3) (1, 2) (0, 1) (3, 2) (1, 2) (0, 1) (3, 4) (2, 3) (1, 2) (3, 2) (4, 3) (3, 2) (2, 1) (1, 2) (0, 1) (2, 3) (1, 2) (2, 1) (3, 2) (3, 4) (4, 3) (3, 2) (1, 2) (2, 3) (3, 2) (2, 1) (1, 2) (0, 1) (1, 2) (3, 4) (2, 3) (1, 2) (4, 3) (2, 3)
NPA-TDG₅₋₁₆: (0, 1) (1, 2) (2, 1) (3, 2) (3, 4) (4, 3) (3, 2) (1, 2) (2, 3) (3, 2) (2, 1) (1, 2) (0, 1) (1, 2) (3, 4) (2, 3) (1, 2) (0, 1) (4, 3) (2, 3) (1, 2) (2, 1) (3, 2) (3, 4) (2, 3) (1, 2) (0, 1) (4, 3) (3, 2) (1, 2) (0, 1) (3, 4) (2, 3) (1, 2) (3, 2) (4, 3) (3, 2) (2, 1) (1, 2) (2, 3)
NPA-TDG₅₋₁₇: (0, 1) (1, 2) (2, 1) (3, 2) (3, 4) (4, 3) (3, 2) (1, 2) (2, 3) (3, 2) (2, 1) (1, 2) (0, 1) (1, 2) (3, 4) (2, 3) (1, 2) (0, 1) (4, 3) (2, 3) (1, 2) (2, 1) (3, 2) (3, 4) (4, 3) (2, 3) (1, 2) (0, 1) (3, 2) (1, 2) (0, 1) (3, 4) (2, 3) (1, 2) (3, 2) (4, 3) (3, 2) (2, 1) (1, 2) (2, 3)
NPA-TDG₅₋₁₈: (0, 1) (1, 2) (2, 1) (3, 2) (4, 3) (2, 3) (1, 2) (0, 1) (3, 2) (1, 2) (0, 1) (3, 4) (2, 3) (1, 2) (3, 2) (4, 3) (3, 2) (2, 1) (1, 2) (0, 1) (2, 3) (1, 2) (2, 1) (3, 2) (3, 4) (4, 3) (3, 2) (1, 2) (2, 3) (3, 2) (2, 1) (1, 2) (0, 1) (1, 2) (3, 4) (2, 3) (1, 2) (4, 3) (2, 3) (3, 4)
NPA-TDG₅₋₁₉: (0, 1) (1, 2) (2, 1) (3, 2) (4, 3) (3, 2) (1, 2) (0, 1) (2, 3) (1, 2) (0, 1) (3, 2) (1, 2) (3, 4) (2, 3) (4, 3) (3, 2) (2, 1) (1, 2) (0, 1) (3, 4) (2, 3) (1, 2) (4, 3) (2, 3) (1, 2) (0, 1) (1, 2) (2, 1) (3, 2) (3, 4) (2, 3) (1, 2) (3, 2) (4, 3) (3, 2) (2, 1) (1, 2) (3, 4) (2, 3)
NPA-TDG₅₋₂₀: (0, 1) (1, 2) (2, 1) (3, 2) (4, 3) (3, 2) (1, 2) (0, 1) (2, 3) (1, 2) (0, 1) (3, 2) (1, 2) (3, 4) (4, 3) (2, 3) (3, 2) (2, 1) (1, 2) (0, 1) (3, 4) (2, 3) (1, 2) (4, 3) (2, 3) (1, 2) (0, 1) (1, 2) (2, 1) (3, 2) (3, 4) (2, 3) (1, 2) (3, 2) (4, 3) (3, 2) (2, 1) (1, 2) (3, 4) (2, 3)
NPA-TDG₅₋₂₁: (0, 1) (1, 2) (2, 1) (3, 2) (4, 3) (3, 2) (1, 2) (2, 3) (3, 2) (2, 1) (1, 2) (0, 1) (1, 2) (3, 4) (2, 3) (1, 2) (0, 1) (4, 3) (2, 3) (1, 2) (2, 1) (3, 2) (3, 4) (2, 3) (1, 2) (0, 1) (4, 3) (3, 2) (1, 2) (0, 1) (3, 4) (2, 3) (1, 2) (3, 2) (4, 3) (3, 2) (2, 1) (1, 2) (2, 3) (3, 4)
NPA-TDG₅₋₂₂: (0, 1) (1, 2) (2, 1) (3, 2) (4, 3) (3, 2) (1, 2) (2, 3) (3, 2) (2, 1) (1, 2) (0, 1) (1, 2) (3, 4) (2, 3) (1, 2) (0, 1) (4, 3) (2, 3) (1, 2) (2, 1) (3, 2) (3, 4) (4, 3) (2, 3) (1, 2) (0, 1) (3, 2) (1, 2) (0, 1) (3, 4) (2, 3) (1, 2) (3, 2) (4, 3) (3, 2) (2, 1) (1, 2) (2, 3) (3, 4)
NPA-TDG₅₋₂₃: (0, 1) (1, 2) (2, 3) (1, 2) (0, 1) (1, 2) (2, 1) (3, 2) (3, 4) (2, 3) (1, 2) (3, 2) (4, 3) (3, 2) (2, 1) (1, 2) (0, 1) (3, 4) (2, 3) (1, 2) (2, 1) (3, 2) (4, 3) (3, 2) (1, 2) (0, 1) (2, 3) (1, 2) (0, 1) (3, 2) (1, 2) (3, 4) (2, 3) (4, 3) (3, 2) (2, 1) (1, 2) (3, 4) (2, 3) (4, 3)
NPA-TDG₅₋₂₄: (0, 1) (1, 2) (2, 3) (1, 2) (0, 1) (1, 2) (2, 1) (3, 2) (3, 4) (2, 3) (1, 2) (3, 2) (4, 3) (3, 2) (2, 1) (1, 2) (0, 1) (3, 4) (2, 3) (1, 2) (2, 1) (3, 2) (4, 3) (3, 2) (1, 2) (0, 1) (2, 3) (1, 2) (0, 1) (3, 2) (1, 2) (3, 4) (4, 3) (2, 3) (3, 2) (2, 1) (1, 2) (3, 4) (2, 3) (4, 3)
NPA-TDG₅₋₂₅: (0, 1) (1, 2) (2, 3) (1, 2) (0, 1) (4, 3) (2, 3) (1, 2) (2, 1) (3, 2) (3, 4) (4, 3) (2, 3) (1, 2) (0, 1) (3, 2) (1, 2) (0, 1) (3, 4) (2, 3) (1, 2) (3, 2) (4, 3) (3, 2) (2, 1) (1, 2) (0, 1) (2, 3) (1, 2) (2, 1) (3, 2) (3, 4) (4, 3) (3, 2) (1, 2) (2, 3) (3, 2) (2, 1) (1, 2) (3, 4)
NPA-TDG₅₋₂₆: (0, 1) (1, 2) (2, 3) (3, 2) (2, 1) (1, 0) (4, 3) (3, 2) (2, 3) (1, 2) (0, 1) (1, 2) (3, 2) (2, 1) (1, 0) (1, 2) (2, 3) (3, 2) (4, 3) (3, 2) (2, 1) (0, 1) (3, 2) (2, 1) (1, 0) (4, 3) (3, 2) (2, 3) (1, 2) (2, 1) (0, 1) (1, 0) (3, 2) (1, 2) (4, 3) (3, 2) (2, 1) (4, 3) (3, 2) (1, 2)
NPA-TDG₅₋₂₇: (0, 1) (1, 2) (2, 3) (4, 3) (3, 2) (2, 1) (1, 2) (0, 1) (3, 4) (2, 3) (1, 2) (4, 3) (2, 3) (1, 2) (0, 1) (1, 2) (2, 1) (3, 2) (3, 4) (2, 3) (1, 2) (3, 2) (4, 3) (3, 2) (2, 1) (1, 2) (0, 1) (3, 4) (2, 3) (1, 2) (2, 1) (3, 2) (4, 3) (3, 2) (1, 2) (0, 1) (2, 3) (1, 2) (3, 2) (3, 4)
NPA-TDG₅₋₂₈: (0, 1) (1, 2) (3, 2) (2, 1) (1, 0) (1, 2) (2, 3) (3, 2) (4, 3) (3, 2) (2, 1) (0, 1) (3, 2) (2, 1) (1, 0) (4, 3) (3, 2) (2, 3) (1, 2) (0, 1) (2, 1) (1, 0) (3, 2) (1, 2) (4, 3) (3, 2) (2, 1) (4, 3) (3, 2) (1, 2) (0, 1) (1, 2) (2, 3) (3, 2) (2, 1) (1, 0) (4, 3) (3, 2) (2, 3) (1, 2)
NPA-TDG₅₋₂₉: (0, 1) (1, 2) (3, 2) (2, 1) (1, 0) (1, 2) (2, 3) (3, 2) (4, 3) (3, 2) (2, 1) (0, 1) (3, 2) (2, 1) (1, 0) (4, 3) (3, 2) (2, 3) (1, 2) (2, 1) (0, 1) (1, 0) (3, 2) (1, 2) (4, 3) (3, 2) (2, 1) (4, 3) (3, 2) (1, 2) (0, 1) (1, 2) (2, 3) (3, 2) (2, 1) (1, 0) (4, 3) (3, 2) (2, 3) (1, 2)
NPA-TDG₅₋₃₀: (0, 1) (1, 2) (3, 2) (2, 1) (1, 0) (4, 3) (3, 2) (1, 2) (0, 1) (4, 3) (3, 2) (2, 1) (1, 0) (1, 2) (2, 3) (3, 2) (2, 1) (0, 1) (4, 3) (3, 2) (2, 1) (1, 0) (3, 2) (4, 3) (3, 2) (2, 3) (1, 2) (2, 1) (3, 2) (1, 2) (0, 1) (1, 0) (1, 2) (2, 3) (3, 2) (2, 1) (4, 3) (3, 2) (2, 3) (1, 2)
NPA-TDG₅₋₃₁: (0, 1) (1, 2) (3, 2) (4, 3) (3, 2) (2, 1) (1, 2) (0, 1) (2, 3) (1, 2) (2, 1) (3, 2) (3, 4) (4, 3) (3, 2) (1, 2) (2, 3) (3, 2) (2, 1) (1, 2) (0, 1) (1, 2) (3, 4) (2, 3) (1, 2) (0, 1) (4, 3) (2, 3) (1, 2) (2, 1) (3, 2) (3, 4) (4, 3) (2, 3) (1, 2) (0, 1) (3, 2) (1, 2) (3, 4) (2, 3)
NPA-TDG₅₋₃₂: (0, 1) (1, 2) (3, 4) (2, 3) (1, 2) (0, 1) (4, 3) (2, 3) (1, 2) (2, 1) (3, 2) (3, 4) (4, 3) (2, 3) (1, 2) (0, 1) (3, 2) (1, 2) (0, 1) (3, 4) (2, 3) (1, 2) (3, 2) (4, 3) (3, 2) (2, 1) (1, 2) (0, 1) (2, 3) (1, 2) (2, 1) (3, 2) (3, 4) (4, 3) (3, 2) (1, 2) (2, 3) (3, 2) (2, 1) (1, 2)
NPA-TDG₅₋₃₃: (0, 1) (1, 2) (3, 4) (2, 3) (4, 3) (3, 2) (2, 1) (1, 2) (0, 1) (3, 4) (2, 3) (1, 2) (4, 3) (2, 3) (1, 2) (0, 1) (1, 2) (2, 1) (3, 2) (3, 4) (2, 3) (1, 2) (3, 2) (4, 3) (3, 2) (2, 1) (1, 2) (0, 1) (3, 4) (2, 3) (1, 2) (2, 1) (3, 2) (4, 3) (3, 2) (1, 2) (0, 1) (2, 3) (1, 2) (3, 2)
NPA-TDG₅₋₃₄: (0, 1) (1, 2) (3, 4) (4, 3) (2, 3) (3, 2) (2, 1) (1, 2) (0, 1) (3, 4) (2, 3) (1, 2) (4, 3) (2, 3) (1, 2) (0, 1) (1, 2) (2, 1) (3, 2) (3, 4) (2, 3) (1, 2) (3, 2) (4, 3) (3, 2) (2, 1) (1, 2) (0, 1) (3, 4) (2, 3) (1, 2) (2, 1) (3, 2) (4, 3) (3, 2) (1, 2) (0, 1) (2, 3) (1, 2) (3, 2)
NPA-TDG₅₋₃₅: (0, 1) (1, 2) (4, 3) (2, 3) (1, 2) (0, 1) (1, 2) (2, 1) (3, 2) (3, 4) (2, 3) (1, 2) (3, 2) (4, 3) (3, 2) (2, 1) (1, 2) (0, 1) (3, 4) (2, 3) (1, 2) (2, 1) (3, 2) (4, 3) (3, 2) (1, 2) (0, 1) (2, 3) (1, 2) (0, 1) (3, 2) (1, 2) (3, 4) (2, 3) (4, 3) (3, 2) (2, 1) (1, 2) (3, 4) (2, 3)
NPA-TDG₅₋₃₆: (0, 1) (1, 2) (4, 3) (2, 3) (3, 2) (2, 1) (1, 2) (0, 1) (3, 4) (2, 3) (1, 2) (4, 3) (2, 3) (1, 2) (0, 1) (1, 2) (2, 1) (3, 2) (3, 4) (2, 3) (1, 2) (3, 2) (4, 3) (3, 2) (2, 1) (1, 2) (0, 1) (3, 4) (2, 3) (1, 2) (2, 1) (3, 2) (4, 3) (3, 2) (1, 2) (0, 1) (2, 3) (1, 2) (3, 2) (3, 4)
NPA-TDG₅₋₃₇: (0, 1) (2, 1) (1, 0) (1, 2) (2, 3) (3, 2) (2, 1) (0, 1) (4, 3) (3, 2) (2, 1) (1, 0) (3, 2) (4, 3) (3, 2) (2, 3) (1, 2) (2, 1) (3, 2) (1, 2) (0, 1) (1, 0) (1, 2) (2, 3) (3, 2) (2, 1) (4, 3) (3, 2) (2, 3) (1, 2) (0, 1) (1, 2) (3, 2) (2, 1) (1, 0) (4, 3) (3, 2) (1, 2) (4, 3) (3, 2)
NPA-TDG₅₋₃₈: (0, 1) (2, 1) (1, 0) (3, 2) (1, 2) (4, 3) (3, 2) (2, 1) (4, 3) (3, 2) (1, 2) (0, 1) (1, 2) (2, 3) (3, 2) (2, 1) (1, 0) (4, 3) (3, 2) (2, 3) (1, 2) (0, 1) (1, 2) (3, 2) (2, 1) (1, 0) (1, 2) (2, 3) (3, 2) (4, 3) (3, 2) (2, 1) (0, 1) (3, 2) (2, 1) (1, 0) (4, 3) (3, 2) (2, 3) (1, 2)
NPA-TDG₅₋₃₉: (0, 1) (2, 1) (1, 0) (3, 2) (4, 3) (3, 2) (2, 3) (1, 2) (2, 1) (3, 2) (1, 2) (0, 1) (1, 0) (1, 2) (2, 3) (3, 2) (2, 1) (4, 3) (3, 2) (2, 3) (1, 2) (0, 1) (1, 2) (3, 2) (2, 1) (1, 0) (4, 3) (3, 2) (1, 2) (0, 1) (4, 3) (3, 2) (2, 1) (1, 0) (1, 2) (2, 3) (3, 2) (2, 1) (4, 3) (3, 2)
NPA-TDG₅₋₄₀: (0, 1) (2, 1) (1, 0) (3, 2) (4, 3) (3, 2) (2, 3) (1, 2) (2, 1) (3, 2) (1, 2) (0, 1) (1, 0) (1, 2) (2, 3) (3, 2) (2, 1) (4, 3) (3, 2) (2, 3) (1, 2) (0, 1) (1, 2) (3, 2) (2, 1) (1, 0) (4, 3) (3, 2) (1, 2) (4, 3) (3, 2) (2, 1) (0, 1) (1, 0) (1, 2) (2, 3) (3, 2) (2, 1) (4, 3) (3, 2)
NPA-TDG₅₋₄₁: (0, 1) (2, 1) (1, 0) (4, 3) (3, 2) (2, 3) (1, 2) (0, 1) (2, 1) (1, 0) (3, 2) (1, 2) (4, 3) (3, 2) (2, 1) (4, 3) (3, 2) (1, 2) (0, 1) (1, 2) (2, 3) (3, 2) (2, 1) (1, 0) (4, 3) (3, 2) (2, 3) (1, 2) (0, 1) (1, 2) (3, 2) (2, 1) (1, 0) (1, 2) (2, 3) (3, 2) (4, 3) (3, 2) (2, 1) (3, 2)
NPA-TDG₅₋₄₂: (0, 1) (2, 1) (1, 0) (4, 3) (3, 2) (2, 3) (1, 2) (2, 1) (0, 1) (1, 0) (3, 2) (1, 2) (4, 3) (3, 2) (2, 1) (4, 3) (3, 2) (1, 2) (0, 1) (1, 2) (2, 3) (3, 2) (2, 1) (1, 0) (4, 3) (3, 2) (2, 3) (1, 2) (0, 1) (1, 2) (3, 2) (2, 1) (1, 0) (1, 2) (2, 3) (3, 2) (4, 3) (3, 2) (2, 1) (3, 2)
NPA-TDG₅₋₄₃: (0, 1) (2, 3) (1, 2) (0, 1) (3, 2) (1, 2) (3, 4) (4, 3) (2, 3) (3, 2) (2, 1) (1, 2) (0, 1) (3, 4) (2, 3) (1, 2) (4, 3) (2, 3) (1, 2) (0, 1) (1, 2) (2, 1) (3, 2) (3, 4) (2, 3) (1, 2) (3, 2) (4, 3) (3, 2) (2, 1) (1, 2) (0, 1) (3, 4) (2, 3) (1, 2) (2, 1) (3, 2) (4, 3) (3, 2) (1, 2)
NPA-TDG₅₋₄₄: (0, 1) (2, 3) (1, 2) (2, 1) (3, 2) (3, 4) (2, 3) (1, 2) (0, 1) (4, 3) (3, 2) (1, 2) (0, 1) (3, 4) (2, 3) (1, 2) (3, 2) (4, 3) (3, 2) (2, 1) (1, 2) (0, 1) (2, 3) (1, 2) (2, 1) (3, 2) (3, 4) (4, 3) (3, 2) (1, 2) (2, 3) (3, 2) (2, 1) (1, 2) (0, 1) (1, 2) (3, 4) (2, 3) (1, 2) (4, 3)
NPA-TDG₅₋₄₅: (0, 1) (2, 3) (1, 2) (2, 1) (3, 2) (3, 4) (4, 3) (2, 3) (1, 2) (0, 1) (3, 2) (1, 2) (0, 1) (3, 4) (2, 3) (1, 2) (3, 2) (4, 3) (3, 2) (2, 1) (1, 2) (0, 1) (2, 3) (1, 2) (2, 1) (3, 2) (3, 4) (4, 3) (3, 2) (1, 2) (2, 3) (3, 2) (2, 1) (1, 2) (0, 1) (1, 2) (3, 4) (2, 3) (1, 2) (4, 3)
NPA-TDG₅₋₄₆: (0, 1) (2, 3) (1, 2) (2, 1) (3, 2) (3, 4) (4, 3) (3, 2) (1, 2) (2, 3) (3, 2) (2, 1) (1, 2) (0, 1) (1, 2) (3, 4) (2, 3) (1, 2) (0, 1) (4, 3) (2, 3) (1, 2) (2, 1) (3, 2) (3, 4) (2, 3) (1, 2) (0, 1) (4, 3) (3, 2) (1, 2) (0, 1) (3, 4) (2, 3) (1, 2) (3, 2) (4, 3) (3, 2) (2, 1) (1, 2)
NPA-TDG₅₋₄₇: (0, 1) (2, 3) (1, 2) (2, 1) (3, 2) (3, 4) (4, 3) (3, 2) (1, 2) (2, 3) (3, 2) (2, 1) (1, 2) (0, 1) (1, 2) (3, 4) (2, 3) (1, 2) (0, 1) (4, 3) (2, 3) (1, 2) (2, 1) (3, 2) (3, 4) (4, 3) (2, 3) (1, 2) (0, 1) (3, 2) (1, 2) (0, 1) (3, 4) (2, 3) (1, 2) (3, 2) (4, 3) (3, 2) (2, 1) (1, 2)
NPA-TDG₅₋₄₈: (0, 1) (2, 3) (1, 2) (2, 1) (3, 2) (4, 3) (3, 2) (1, 2) (0, 1) (2, 3) (1, 2) (0, 1) (3, 2) (1, 2) (3, 4) (2, 3) (4, 3) (3, 2) (2, 1) (1, 2) (0, 1) (3, 4) (2, 3) (1, 2) (4, 3) (2, 3) (1, 2) (0, 1) (1, 2) (2, 1) (3, 2) (3, 4) (2, 3) (1, 2) (3, 2) (4, 3) (3, 2) (2, 1) (1, 2) (3, 4)
NPA-TDG₅₋₄₉: (0, 1) (2, 3) (1, 2) (2, 1) (3, 2) (4, 3) (3, 2) (1, 2) (0, 1) (2, 3) (1, 2) (0, 1) (3, 2) (1, 2) (3, 4) (4, 3) (2, 3) (3, 2) (2, 1) (1, 2) (0, 1) (3, 4) (2, 3) (1, 2) (4, 3) (2, 3) (1, 2) (0, 1) (1, 2) (2, 1) (3, 2) (3, 4) (2, 3) (1, 2) (3, 2) (4, 3) (3, 2) (2, 1) (1, 2) (3, 4)
NPA-TDG₅₋₅₀: (0, 1) (2, 3) (1, 2) (4, 3) (2, 3) (1, 2) (0, 1) (1, 2) (2, 1) (3, 2) (3, 4) (2, 3) (1, 2) (3, 2) (4, 3) (3, 2) (2, 1) (1, 2) (0, 1) (3, 4) (2, 3) (1, 2) (2, 1) (3, 2) (4, 3) (3, 2) (1, 2) (0, 1) (2, 3) (1, 2) (0, 1) (3, 2) (1, 2) (3, 4) (2, 3) (4, 3) (3, 2) (2, 1) (1, 2) (3, 4)
NPA-TDG₅₋₅₁: (0, 1) (3, 2) (1, 2) (0, 1) (2, 3) (1, 2) (3, 2) (4, 3) (3, 2) (2, 1) (1, 2) (0, 1) (2, 3) (1, 2) (2, 1) (3, 2) (3, 4) (4, 3) (3, 2) (1, 2) (2, 3) (3, 2) (2, 1) (1, 2) (0, 1) (1, 2) (3, 4) (2, 3) (1, 2) (0, 1) (4, 3) (2, 3) (1, 2) (2, 1) (3, 2) (3, 4) (2, 3) (1, 2) (4, 3) (3, 4)
NPA-TDG₅₋₅₂: (0, 1) (3, 2) (1, 2) (0, 1) (3, 4) (2, 3) (1, 2) (3, 2) (4, 3) (3, 2) (2, 1) (1, 2) (0, 1) (2, 3) (1, 2) (2, 1) (3, 2) (3, 4) (4, 3) (3, 2) (1, 2) (2, 3) (3, 2) (2, 1) (1, 2) (0, 1) (1, 2) (3, 4) (2, 3) (1, 2) (0, 1) (4, 3) (2, 3) (1, 2) (2, 1) (3, 2) (3, 4) (2, 3) (1, 2) (4, 3)
NPA-TDG₅₋₅₃: (0, 1) (3, 2) (1, 2) (0, 1) (3, 4) (2, 3) (1, 2) (3, 2) (4, 3) (3, 2) (2, 1) (1, 2) (0, 1) (2, 3) (1, 2) (2, 1) (3, 2) (3, 4) (4, 3) (3, 2) (1, 2) (2, 3) (3, 2) (2, 1) (1, 2) (0, 1) (1, 2) (3, 4) (2, 3) (1, 2) (0, 1) (4, 3) (2, 3) (1, 2) (2, 1) (3, 2) (3, 4) (4, 3) (2, 3) (1, 2)
NPA-TDG₅₋₅₄: (0, 1) (3, 2) (1, 2) (2, 3) (4, 3) (3, 2) (2, 1) (1, 2) (0, 1) (3, 4) (2, 3) (1, 2) (4, 3) (2, 3) (1, 2) (0, 1) (1, 2) (2, 1) (3, 2) (3, 4) (2, 3) (1, 2) (3, 2) (4, 3) (3, 2) (2, 1) (1, 2) (0, 1) (3, 4) (2, 3) (1, 2) (2, 1) (3, 2) (4, 3) (3, 2) (1, 2) (0, 1) (2, 3) (1, 2) (3, 4)
NPA-TDG₅₋₅₅: (0, 1) (3, 2) (1, 2) (3, 4) (2, 3) (4, 3) (3, 2) (2, 1) (1, 2) (0, 1) (3, 4) (2, 3) (1, 2) (4, 3) (2, 3) (1, 2) (0, 1) (1, 2) (2, 1) (3, 2) (3, 4) (2, 3) (1, 2) (3, 2) (4, 3) (3, 2) (2, 1) (1, 2) (0, 1) (3, 4) (2, 3) (1, 2) (2, 1) (3, 2) (4, 3) (3, 2) (1, 2) (0, 1) (2, 3) (1, 2)
NPA-TDG₅₋₅₆: (0, 1) (3, 2) (2, 1) (1, 0) (4, 3) (3, 2) (2, 3) (1, 2) (0, 1) (2, 1) (1, 0) (3, 2) (1, 2) (4, 3) (3, 2) (2, 1) (4, 3) (3, 2) (1, 2) (0, 1) (1, 2) (2, 3) (3, 2) (2, 1) (1, 0) (4, 3) (3, 2) (2, 3) (1, 2) (0, 1) (1, 2) (3, 2) (2, 1) (1, 0) (1, 2) (2, 3) (3, 2) (4, 3) (3, 2) (2, 1)
NPA-TDG₅₋₅₇: (0, 1) (3, 2) (2, 1) (1, 0) (4, 3) (3, 2) (2, 3) (1, 2) (2, 1) (0, 1) (1, 0) (3, 2) (1, 2) (4, 3) (3, 2) (2, 1) (4, 3) (3, 2) (1, 2) (0, 1) (1, 2) (2, 3) (3, 2) (2, 1) (1, 0) (4, 3) (3, 2) (2, 3) (1, 2) (0, 1) (1, 2) (3, 2) (2, 1) (1, 0) (1, 2) (2, 3) (3, 2) (4, 3) (3, 2) (2, 1)
NPA-TDG₅₋₅₈: (0, 1) (3, 4) (2, 3) (1, 2) (2, 1) (3, 2) (4, 3) (3, 2) (1, 2) (0, 1) (2, 3) (1, 2) (0, 1) (3, 2) (1, 2) (3, 4) (2, 3) (4, 3) (3, 2) (2, 1) (1, 2) (0, 1) (3, 4) (2, 3) (1, 2) (4, 3) (2, 3) (1, 2) (0, 1) (1, 2) (2, 1) (3, 2) (3, 4) (2, 3) (1, 2) (3, 2) (4, 3) (3, 2) (2, 1) (1, 2)
NPA-TDG₅₋₅₉: (0, 1) (3, 4) (2, 3) (1, 2) (2, 1) (3, 2) (4, 3) (3, 2) (1, 2) (0, 1) (2, 3) (1, 2) (0, 1) (3, 2) (1, 2) (3, 4) (4, 3) (2, 3) (3, 2) (2, 1) (1, 2) (0, 1) (3, 4) (2, 3) (1, 2) (4, 3) (2, 3) (1, 2) (0, 1) (1, 2) (2, 1) (3, 2) (3, 4) (2, 3) (1, 2) (3, 2) (4, 3) (3, 2) (2, 1) (1, 2)
NPA-TDG₅₋₆₀: (0, 1) (3, 4) (2, 3) (1, 2) (3, 2) (4, 3) (3, 2) (2, 1) (1, 2) (0, 1) (2, 3) (1, 2) (2, 1) (3, 2) (3, 4) (4, 3) (3, 2) (1, 2) (2, 3) (3, 2) (2, 1) (1, 2) (0, 1) (1, 2) (3, 4) (2, 3) (1, 2) (0, 1) (4, 3) (2, 3) (1, 2) (2, 1) (3, 2) (3, 4) (4, 3) (2, 3) (1, 2) (0, 1) (3, 2) (1, 2)
NPA-TDG₅₋₆₁: (0, 1) (3, 4) (2, 3) (1, 2) (4, 3) (2, 3) (1, 2) (0, 1) (1, 2) (2, 1) (3, 2) (3, 4) (2, 3) (1, 2) (3, 2) (4, 3) (3, 2) (2, 1) (1, 2) (0, 1) (3, 4) (2, 3) (1, 2) (2, 1) (3, 2) (4, 3) (3, 2) (1, 2) (0, 1) (2, 3) (1, 2) (0, 1) (3, 2) (1, 2) (3, 4) (2, 3) (4, 3) (3, 2) (2, 1) (1, 2)
NPA-TDG₅₋₆₂: (1, 0) (0, 1) (1, 2) (3, 2) (2, 1) (1, 0) (1, 2) (2, 3) (3, 2) (4, 3) (3, 2) (2, 1) (0, 1) (3, 2) (2, 1) (1, 0) (4, 3) (3, 2) (2, 3) (1, 2) (0, 1) (2, 1) (1, 0) (3, 2) (1, 2) (4, 3) (3, 2) (2, 1) (4, 3) (3, 2) (1, 2) (0, 1) (1, 2) (2, 3) (3, 2) (2, 1) (4, 3) (3, 2) (2, 3) (1, 2)
NPA-TDG₅₋₆₃: (1, 0) (0, 1) (2, 1) (1, 0) (1, 2) (2, 3) (3, 2) (2, 1) (0, 1) (4, 3) (3, 2) (2, 1) (1, 0) (3, 2) (4, 3) (3, 2) (2, 3) (1, 2) (2, 1) (3, 2) (1, 2) (0, 1) (1, 0) (1, 2) (2, 3) (3, 2) (2, 1) (4, 3) (3, 2) (2, 3) (1, 2) (0, 1) (1, 2) (3, 2) (2, 1) (4, 3) (3, 2) (1, 2) (4, 3) (3, 2)
NPA-TDG₅₋₆₄: (1, 0) (0, 1) (2, 1) (1, 0) (3, 2) (1, 2) (4, 3) (3, 2) (2, 1) (4, 3) (3, 2) (1, 2) (0, 1) (1, 2) (2, 3) (3, 2) (2, 1) (1, 0) (4, 3) (3, 2) (2, 3) (1, 2) (0, 1) (1, 2) (3, 2) (2, 1) (1, 0) (1, 2) (2, 3) (3, 2) (4, 3) (3, 2) (2, 1) (0, 1) (3, 2) (2, 1) (4, 3) (3, 2) (2, 3) (1, 2)
NPA-TDG₅₋₆₅: (1, 0) (1, 2) (0, 1) (1, 2) (3, 2) (2, 1) (1, 0) (1, 2) (2, 3) (3, 2) (4, 3) (3, 2) (2, 1) (0, 1) (3, 2) (2, 1) (1, 0) (4, 3) (3, 2) (2, 3) (1, 2) (0, 1) (2, 1) (1, 0) (3, 2) (1, 2) (4, 3) (3, 2) (2, 1) (4, 3) (3, 2) (1, 2) (0, 1) (1, 2) (2, 3) (3, 2) (2, 1) (4, 3) (3, 2) (2, 3)
NPA-TDG₅₋₆₆: (1, 0) (1, 2) (0, 1) (1, 2) (3, 2) (2, 1) (1, 0) (1, 2) (2, 3) (3, 2) (4, 3) (3, 2) (2, 1) (0, 1) (3, 2) (2, 1) (1, 0) (4, 3) (3, 2) (2, 3) (1, 2) (2, 1) (0, 1) (1, 0) (3, 2) (1, 2) (4, 3) (3, 2) (2, 1) (4, 3) (3, 2) (1, 2) (0, 1) (1, 2) (2, 3) (3, 2) (2, 1) (4, 3) (3, 2) (2, 3)
NPA-TDG₅₋₆₇: (1, 0) (1, 2) (0, 1) (2, 1) (1, 0) (3, 2) (1, 2) (4, 3) (3, 2) (2, 1) (4, 3) (3, 2) (1, 2) (0, 1) (1, 2) (2, 3) (3, 2) (2, 1) (1, 0) (4, 3) (3, 2) (2, 3) (1, 2) (0, 1) (1, 2) (3, 2) (2, 1) (1, 0) (1, 2) (2, 3) (3, 2) (4, 3) (3, 2) (2, 1) (0, 1) (3, 2) (2, 1) (4, 3) (3, 2) (2, 3)
NPA-TDG₅₋₆₈: (1, 0) (1, 2) (2, 1) (3, 2) (1, 2) (0, 1) (1, 0) (1, 2) (2, 3) (3, 2) (2, 1) (4, 3) (3, 2) (2, 3) (1, 2) (0, 1) (1, 2) (3, 2) (2, 1) (1, 0) (4, 3) (3, 2) (1, 2) (4, 3) (3, 2) (2, 1) (0, 1) (1, 0) (1, 2) (2, 3) (3, 2) (2, 1) (0, 1) (4, 3) (3, 2) (2, 1) (3, 2) (4, 3) (3, 2) (2, 3)
NPA-TDG₅₋₆₉: (1, 0) (1, 2) (2, 3) (3, 2) (4, 3) (3, 2) (2, 1) (0, 1) (3, 2) (2, 1) (1, 0) (4, 3) (3, 2) (2, 3) (1, 2) (0, 1) (2, 1) (1, 0) (3, 2) (1, 2) (4, 3) (3, 2) (2, 1) (4, 3) (3, 2) (1, 2) (0, 1) (1, 2) (2, 3) (3, 2) (2, 1) (1, 0) (4, 3) (3, 2) (2, 3) (1, 2) (0, 1) (1, 2) (3, 2) (2, 1)
NPA-TDG₅₋₇₀: (1, 0) (1, 2) (2, 3) (3, 2) (4, 3) (3, 2) (2, 1) (0, 1) (3, 2) (2, 1) (1, 0) (4, 3) (3, 2) (2, 3) (1, 2) (2, 1) (0, 1) (1, 0) (3, 2) (1, 2) (4, 3) (3, 2) (2, 1) (4, 3) (3, 2) (1, 2) (0, 1) (1, 2) (2, 3) (3, 2) (2, 1) (1, 0) (4, 3) (3, 2) (2, 3) (1, 2) (0, 1) (1, 2) (3, 2) (2, 1)
NPA-TDG₅₋₇₁: (1, 0) (2, 1) (0, 1) (1, 0) (1, 2) (2, 3) (3, 2) (2, 1) (0, 1) (4, 3) (3, 2) (2, 1) (1, 0) (3, 2) (4, 3) (3, 2) (2, 3) (1, 2) (2, 1) (3, 2) (1, 2) (0, 1) (1, 0) (1, 2) (2, 3) (3, 2) (2, 1) (4, 3) (3, 2) (2, 3) (1, 2) (0, 1) (1, 2) (3, 2) (2, 1) (4, 3) (3, 2) (1, 2) (4, 3) (3, 2)
NPA-TDG₅₋₇₂: (1, 0) (2, 1) (0, 1) (3, 2) (2, 1) (1, 0) (4, 3) (3, 2) (2, 3) (1, 2) (0, 1) (2, 1) (1, 0) (3, 2) (1, 2) (4, 3) (3, 2) (2, 1) (4, 3) (3, 2) (1, 2) (0, 1) (1, 2) (2, 3) (3, 2) (2, 1) (1, 0) (4, 3) (3, 2) (2, 3) (1, 2) (0, 1) (1, 2) (3, 2) (2, 1) (1, 2) (2, 3) (3, 2) (4, 3) (3, 2)
NPA-TDG₅₋₇₃: (1, 0) (2, 1) (3, 2) (1, 2) (0, 1) (1, 0) (1, 2) (2, 3) (3, 2) (2, 1) (4, 3) (3, 2) (2, 3) (1, 2) (0, 1) (1, 2) (3, 2) (2, 1) (1, 0) (4, 3) (3, 2) (1, 2) (4, 3) (3, 2) (2, 1) (0, 1) (1, 0) (1, 2) (2, 3) (3, 2) (2, 1) (0, 1) (4, 3) (3, 2) (2, 1) (3, 2) (4, 3) (3, 2) (2, 3) (1, 2)
NPA-TDG₅₋₇₄: (1, 0) (2, 3) (1, 2) (0, 1) (1, 2) (3, 2) (2, 1) (1, 0) (1, 2) (2, 3) (3, 2) (4, 3) (3, 2) (2, 1) (0, 1) (3, 2) (2, 1) (1, 0) (4, 3) (3, 2) (2, 3) (1, 2) (0, 1) (2, 1) (1, 0) (3, 2) (1, 2) (4, 3) (3, 2) (2, 1) (4, 3) (3, 2) (1, 2) (0, 1) (1, 2) (2, 3) (3, 2) (2, 1) (4, 3) (3, 2)
NPA-TDG₅₋₇₅: (1, 0) (2, 3) (1, 2) (0, 1) (1, 2) (3, 2) (2, 1) (1, 0) (1, 2) (2, 3) (3, 2) (4, 3) (3, 2) (2, 1) (0, 1) (3, 2) (2, 1) (1, 0) (4, 3) (3, 2) (2, 3) (1, 2) (2, 1) (0, 1) (1, 0) (3, 2) (1, 2) (4, 3) (3, 2) (2, 1) (4, 3) (3, 2) (1, 2) (0, 1) (1, 2) (2, 3) (3, 2) (2, 1) (4, 3) (3, 2)
NPA-TDG₅₋₇₆: (1, 0) (2, 3) (1, 2) (0, 1) (2, 1) (1, 0) (3, 2) (1, 2) (4, 3) (3, 2) (2, 1) (4, 3) (3, 2) (1, 2) (0, 1) (1, 2) (2, 3) (3, 2) (2, 1) (1, 0) (4, 3) (3, 2) (2, 3) (1, 2) (0, 1) (1, 2) (3, 2) (2, 1) (1, 0) (1, 2) (2, 3) (3, 2) (4, 3) (3, 2) (2, 1) (0, 1) (3, 2) (2, 1) (4, 3) (3, 2)
NPA-TDG₅₋₇₇: (1, 0) (2, 3) (1, 2) (2, 1) (0, 1) (1, 0) (3, 2) (1, 2) (4, 3) (3, 2) (2, 1) (4, 3) (3, 2) (1, 2) (0, 1) (1, 2) (2, 3) (3, 2) (2, 1) (1, 0) (4, 3) (3, 2) (2, 3) (1, 2) (0, 1) (1, 2) (3, 2) (2, 1) (1, 0) (1, 2) (2, 3) (3, 2) (4, 3) (3, 2) (2, 1) (0, 1) (3, 2) (2, 1) (4, 3) (3, 2)
NPA-TDG₅₋₇₈: (1, 0) (2, 3) (1, 2) (2, 1) (3, 2) (1, 2) (0, 1) (1, 0) (1, 2) (2, 3) (3, 2) (2, 1) (4, 3) (3, 2) (2, 3) (1, 2) (0, 1) (1, 2) (3, 2) (2, 1) (1, 0) (4, 3) (3, 2) (1, 2) (4, 3) (3, 2) (2, 1) (0, 1) (1, 0) (1, 2) (2, 3) (3, 2) (2, 1) (0, 1) (4, 3) (3, 2) (2, 1) (3, 2) (4, 3) (3, 2)
NPA-TDG₅₋₇₉: (1, 0) (2, 3) (3, 2) (2, 1) (0, 1) (4, 3) (3, 2) (2, 1) (1, 0) (3, 2) (4, 3) (3, 2) (2, 3) (1, 2) (2, 1) (3, 2) (1, 2) (0, 1) (1, 0) (1, 2) (2, 3) (3, 2) (2, 1) (4, 3) (3, 2) (2, 3) (1, 2) (0, 1) (1, 2) (3, 2) (2, 1) (1, 0) (4, 3) (3, 2) (1, 2) (4, 3) (3, 2) (2, 1) (0, 1) (1, 2)
NPA-TDG₅₋₈₀: (1, 0) (2, 3) (3, 2) (2, 1) (4, 3) (3, 2) (2, 3) (1, 2) (0, 1) (1, 2) (3, 2) (2, 1) (1, 0) (4, 3) (3, 2) (1, 2) (4, 3) (3, 2) (2, 1) (0, 1) (1, 0) (1, 2) (2, 3) (3, 2) (2, 1) (0, 1) (4, 3) (3, 2) (2, 1) (1, 0) (3, 2) (4, 3) (3, 2) (2, 3) (1, 2) (2, 1) (3, 2) (1, 2) (0, 1) (1, 2)
NPA-TDG₅₋₈₁: (1, 0) (2, 3) (3, 2) (4, 3) (3, 2) (2, 1) (0, 1) (3, 2) (2, 1) (1, 0) (4, 3) (3, 2) (2, 3) (1, 2) (0, 1) (2, 1) (1, 0) (3, 2) (1, 2) (4, 3) (3, 2) (2, 1) (4, 3) (3, 2) (1, 2) (0, 1) (1, 2) (2, 3) (3, 2) (2, 1) (1, 0) (4, 3) (3, 2) (2, 3) (1, 2) (0, 1) (1, 2) (3, 2) (2, 1) (1, 2)
NPA-TDG₅₋₈₂: (1, 0) (3, 2) (1, 2) (4, 3) (3, 2) (2, 1) (4, 3) (3, 2) (1, 2) (0, 1) (1, 2) (2, 3) (3, 2) (2, 1) (1, 0) (4, 3) (3, 2) (2, 3) (1, 2) (0, 1) (1, 2) (3, 2) (2, 1) (1, 0) (1, 2) (2, 3) (3, 2) (4, 3) (3, 2) (2, 1) (0, 1) (3, 2) (2, 1) (1, 0) (4, 3) (3, 2) (2, 3) (1, 2) (0, 1) (2, 1)
NPA-TDG₅₋₈₃: (1, 0) (3, 2) (2, 1) (0, 1) (4, 3) (3, 2) (2, 1) (1, 0) (3, 2) (4, 3) (3, 2) (2, 3) (1, 2) (2, 1) (3, 2) (1, 2) (0, 1) (1, 0) (1, 2) (2, 3) (3, 2) (2, 1) (4, 3) (3, 2) (2, 3) (1, 2) (0, 1) (1, 2) (3, 2) (2, 1) (1, 0) (4, 3) (3, 2) (1, 2) (4, 3) (3, 2) (2, 1) (0, 1) (1, 2) (2, 3)
NPA-TDG₅₋₈₄: (1, 0) (3, 2) (2, 1) (4, 3) (3, 2) (2, 3) (1, 2) (0, 1) (1, 2) (3, 2) (2, 1) (1, 0) (4, 3) (3, 2) (1, 2) (0, 1) (4, 3) (3, 2) (2, 1) (1, 0) (1, 2) (2, 3) (3, 2) (2, 1) (0, 1) (4, 3) (3, 2) (2, 1) (1, 0) (3, 2) (4, 3) (3, 2) (2, 3) (1, 2) (2, 1) (3, 2) (1, 2) (0, 1) (1, 2) (2, 3)
NPA-TDG₅₋₈₅: (1, 0) (3, 2) (2, 1) (4, 3) (3, 2) (2, 3) (1, 2) (0, 1) (1, 2) (3, 2) (2, 1) (1, 0) (4, 3) (3, 2) (1, 2) (4, 3) (3, 2) (2, 1) (0, 1) (1, 0) (1, 2) (2, 3) (3, 2) (2, 1) (0, 1) (4, 3) (3, 2) (2, 1) (1, 0) (3, 2) (4, 3) (3, 2) (2, 3) (1, 2) (2, 1) (3, 2) (1, 2) (0, 1) (1, 2) (2, 3)
NPA-TDG₅₋₈₆: (1, 0) (3, 2) (4, 3) (3, 2) (2, 1) (0, 1) (3, 2) (2, 1) (1, 0) (4, 3) (3, 2) (2, 3) (1, 2) (0, 1) (2, 1) (1, 0) (3, 2) (1, 2) (4, 3) (3, 2) (2, 1) (4, 3) (3, 2) (1, 2) (0, 1) (1, 2) (2, 3) (3, 2) (2, 1) (1, 0) (4, 3) (3, 2) (2, 3) (1, 2) (0, 1) (1, 2) (3, 2) (2, 1) (1, 2) (2, 3)
NPA-TDG₅₋₈₇: (1, 0) (3, 2) (4, 3) (3, 2) (2, 3) (1, 2) (2, 1) (3, 2) (1, 2) (0, 1) (1, 0) (1, 2) (2, 3) (3, 2) (2, 1) (4, 3) (3, 2) (2, 3) (1, 2) (0, 1) (1, 2) (3, 2) (2, 1) (1, 0) (4, 3) (3, 2) (1, 2) (0, 1) (4, 3) (3, 2) (2, 1) (1, 0) (1, 2) (2, 3) (3, 2) (2, 1) (0, 1) (4, 3) (3, 2) (2, 1)
NPA-TDG₅₋₈₈: (1, 0) (3, 2) (4, 3) (3, 2) (2, 3) (1, 2) (2, 1) (3, 2) (1, 2) (0, 1) (1, 0) (1, 2) (2, 3) (3, 2) (2, 1) (4, 3) (3, 2) (2, 3) (1, 2) (0, 1) (1, 2) (3, 2) (2, 1) (1, 0) (4, 3) (3, 2) (1, 2) (4, 3) (3, 2) (2, 1) (0, 1) (1, 0) (1, 2) (2, 3) (3, 2) (2, 1) (0, 1) (4, 3) (3, 2) (2, 1)
NPA-TDG₅₋₈₉: (1, 2) (0, 1) (1, 0) (1, 2) (2, 3) (3, 2) (2, 1) (4, 3) (3, 2) (2, 3) (1, 2) (0, 1) (1, 2) (3, 2) (2, 1) (1, 0) (4, 3) (3, 2) (1, 2) (0, 1) (4, 3) (3, 2) (2, 1) (1, 0) (1, 2) (2, 3) (3, 2) (2, 1) (0, 1) (4, 3) (3, 2) (2, 1) (1, 0) (3, 2) (4, 3) (3, 2) (2, 3) (1, 2) (2, 1) (3, 2)
NPA-TDG₅₋₉₀: (1, 2) (0, 1) (1, 0) (1, 2) (2, 3) (3, 2) (2, 1) (4, 3) (3, 2) (2, 3) (1, 2) (0, 1) (1, 2) (3, 2) (2, 1) (1, 0) (4, 3) (3, 2) (1, 2) (4, 3) (3, 2) (2, 1) (0, 1) (1, 0) (1, 2) (2, 3) (3, 2) (2, 1) (0, 1) (4, 3) (3, 2) (2, 1) (1, 0) (3, 2) (4, 3) (3, 2) (2, 3) (1, 2) (2, 1) (3, 2)
NPA-TDG₅₋₉₁: (1, 2) (0, 1) (1, 2) (2, 3) (3, 2) (2, 1) (1, 0) (4, 3) (3, 2) (2, 3) (1, 2) (0, 1) (1, 2) (3, 2) (2, 1) (1, 0) (1, 2) (2, 3) (3, 2) (4, 3) (3, 2) (2, 1) (0, 1) (3, 2) (2, 1) (1, 0) (4, 3) (3, 2) (2, 3) (1, 2) (0, 1) (2, 1) (1, 0) (3, 2) (1, 2) (4, 3) (3, 2) (2, 1) (4, 3) (3, 2)
NPA-TDG₅₋₉₂: (1, 2) (0, 1) (1, 2) (3, 2) (2, 1) (1, 0) (4, 3) (3, 2) (1, 2) (4, 3) (3, 2) (2, 1) (0, 1) (1, 0) (1, 2) (2, 3) (3, 2) (2, 1) (0, 1) (4, 3) (3, 2) (2, 1) (1, 0) (3, 2) (4, 3) (3, 2) (2, 3) (1, 2) (2, 1) (3, 2) (1, 2) (0, 1) (1, 0) (1, 2) (2, 3) (3, 2) (2, 1) (4, 3) (3, 2) (2, 3)
NPA-TDG₅₋₉₃: (1, 2) (0, 1) (2, 3) (1, 2) (2, 1) (3, 2) (3, 4) (4, 3) (3, 2) (1, 2) (2, 3) (3, 2) (2, 1) (1, 2) (0, 1) (1, 2) (3, 4) (2, 3) (1, 2) (0, 1) (4, 3) (2, 3) (1, 2) (2, 1) (3, 2) (3, 4) (2, 3) (1, 2) (0, 1) (4, 3) (3, 2) (1, 2) (0, 1) (3, 4) (2, 3) (1, 2) (3, 2) (4, 3) (3, 2) (2, 1)
NPA-TDG₅₋₉₄: (1, 2) (0, 1) (2, 3) (1, 2) (2, 1) (3, 2) (3, 4) (4, 3) (3, 2) (1, 2) (2, 3) (3, 2) (2, 1) (1, 2) (0, 1) (1, 2) (3, 4) (2, 3) (1, 2) (0, 1) (4, 3) (2, 3) (1, 2) (2, 1) (3, 2) (3, 4) (4, 3) (2, 3) (1, 2) (0, 1) (3, 2) (1, 2) (0, 1) (3, 4) (2, 3) (1, 2) (3, 2) (4, 3) (3, 2) (2, 1)
NPA-TDG₅₋₉₅: (1, 2) (3, 2) (4, 3) (3, 2) (2, 1) (1, 2) (0, 1) (3, 4) (2, 3) (1, 2) (2, 1) (3, 2) (4, 3) (3, 2) (1, 2) (0, 1) (2, 3) (1, 2) (0, 1) (3, 2) (1, 2) (3, 4) (2, 3) (4, 3) (3, 2) (2, 1) (1, 2) (0, 1) (3, 4) (2, 3) (1, 2) (4, 3) (2, 3) (1, 2) (0, 1) (1, 2) (2, 1) (3, 2) (3, 4) (2, 3)
NPA-TDG₅₋₉₆: (1, 2) (3, 2) (4, 3) (3, 2) (2, 1) (1, 2) (0, 1) (3, 4) (2, 3) (1, 2) (2, 1) (3, 2) (4, 3) (3, 2) (1, 2) (0, 1) (2, 3) (1, 2) (0, 1) (3, 2) (1, 2) (3, 4) (4, 3) (2, 3) (3, 2) (2, 1) (1, 2) (0, 1) (3, 4) (2, 3) (1, 2) (4, 3) (2, 3) (1, 2) (0, 1) (1, 2) (2, 1) (3, 2) (3, 4) (2, 3)
   In a similar fashion to FIG. 4C, adding the phase gates (P) to follow each of the CX gates in the sequences above results in the circuits corresponding to the NPA-TDG₅₋ᵢ gates, i=1, 2, . . . 96.

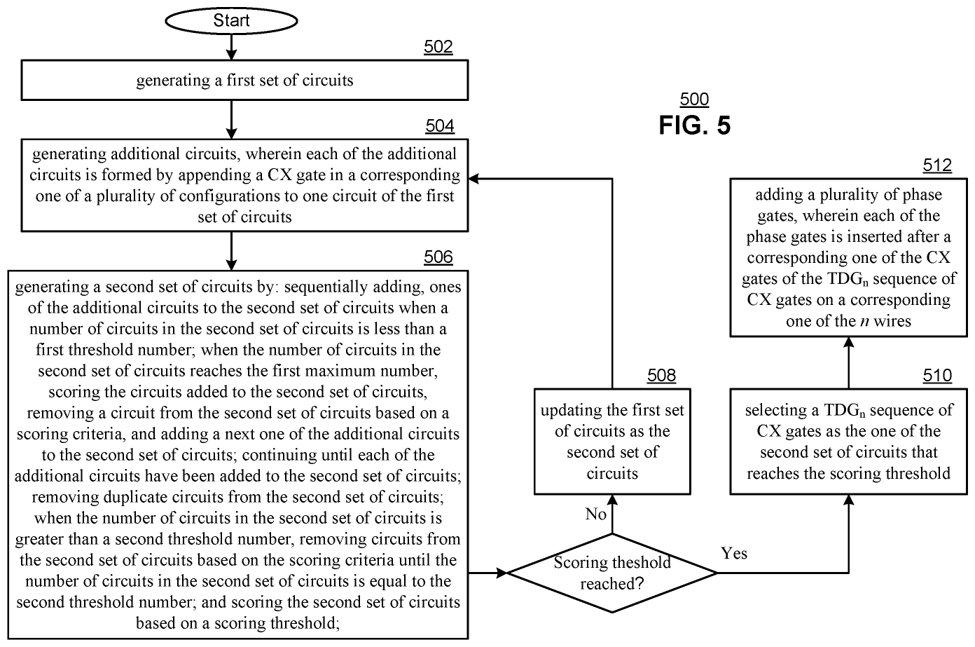

FIG. 5 is a flow diagram of an example method. In particular a method 500 is presented for use with one or more functions and features described in conjunction herein for generating a TDGₙ circuit (e.g. NPA-TDGₙ or SPA-TDGₙ) having z wires on a restricted topology, where n is greater than 3. Step 502 includes generating a first set of circuits. Step 504 includes generating additional circuits, wherein each of the additional circuits is formed by appending a CX gate in a corresponding one of a plurality of configurations to one circuit of the first set of circuits. Step 506 includes generating a second set of circuits by: sequentially adding, ones of the additional circuits to the second set of circuits when a number of circuits in the second set of circuits is less than a first threshold number; when the number of circuits in the second set of circuits reaches the first maximum number, scoring the circuits added to the second set of circuits, removing a circuit from the second set of circuits based on a scoring criteria, and adding a next one of the additional circuits to the second set of circuits; continuing until each of the additional circuits have been added to the second set of circuits; removing duplicate circuits from the second set of circuits; when the number of circuits in the second set of circuits is greater than a second threshold number, removing circuits from the second set of circuits based on the scoring criteria until the number of circuits in the second set of circuits is equal to the second threshold number; and scoring the second set of circuits based on a scoring threshold.

When none of the second set of circuits reaches the scoring threshold, the method proceeds to step 508 which includes updating the first set of circuits as the second set of circuits. The method proceeds to repeat steps 504 and 506. When one of the second set of circuits reaches the scoring threshold, the method proceeds to step 510 which includes selecting a TDGₙ sequence of CX gates as the one of the second set of circuits that reaches the scoring threshold. Step 512 includes adding a plurality of phase gates, wherein each of the phase gates is inserted after a corresponding one of the CX gates of the TDGₙ sequence of CX gates on a corresponding one of the n wires.

In addition or in the alternative, n=5 and the TDGₙ sequence of CX gates comprises a SPA-TDG₅ sequence of CX gates on five wires.

In addition or in the alternative, each of the phase gates is inserted after a corresponding one of the CX gates of the SPA-TDG₅ sequence of CX gates on a corresponding one of the five wires.

In addition or in the alternative, n=4 and the TDGₙ sequence of CX gates comprises a SPA-TDG₄ sequence of CX gates on four wires.

In addition or in the alternative, each of the phase gates is inserted after a corresponding one of the CX gates of the SPA-TDG₄ sequence of CX gates on a corresponding one of the four wires.

In addition or in the alternative, n=5 and the TDGₙ sequence of CX gates comprises a NPA-TDG₅ sequence of CX gates on five wires.

In addition or in the alternative, each of the phase gates is inserted after a corresponding one of the CX gates of the NPA-TDG₅ sequence of CX gates on a corresponding one of the five wires.

In addition or in the alternative, n=4 and the TDGₙ sequence of CX gates comprises a NPA-TDG₄ sequence of CX gates on four wires.

In addition or in the alternative, each of the phase gates is inserted after a corresponding one of the CX gates of the NPA-TDG₄ sequence of CX gates on a corresponding one of the four wires.

In addition or in the alternative, z=4 or 5 and the SPAₙ sequence of CX gates comprises a WPA-TDGₙ.

In addition or in the alternative, a quantum circuit comprises a TDGₙ circuit generated by any of the methodologies described above.

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’).

As may be used herein, the terms “substantially” and “approximately” provides an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more examples have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more examples are used herein to illustrate one or more aspects, one or more features, one or more concepts, and/or one or more examples. A physical example of an apparatus, an article of manufacture, a machine, and/or of a process may include one or more of the aspects, features, concepts, examples, etc. described with reference to one or more of the examples discussed herein. Further, from figure to figure, the examples may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the examples. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

One or more functions associated with the methods and/or processes described herein can be implemented via a processing module that operates via the non-human “artificial” intelligence (AI) of a machine. Examples of such AI include machines that operate via anomaly detection techniques, decision trees, association rules, expert systems and other knowledge-based systems, computer vision models, artificial neural networks, convolutional neural networks, support vector machines (SVMs), Bayesian networks, genetic algorithms, feature learning, sparse dictionary learning, preference learning, deep learning and other machine learning techniques that are trained using training data via unsupervised, semi-supervised, supervised and/or reinforcement learning, and/or other AI. The human mind is not equipped to perform such AI techniques, not only due to the complexity of these techniques, but also due to the fact that artificial intelligence, by its very definition—requires “artificial” intelligence—i.e. machine/non-human intelligence.

One or more functions associated with the methods and/or processes described herein can be implemented as a large-scale system that is operable to receive, transmit and/or process data on a large-scale. As used herein, a large-scale refers to a large number of data, such as one or more kilobytes, megabytes, gigabytes, terabytes or more of data that are received, transmitted and/or processed. Such receiving, transmitting and/or processing of data cannot practically be performed by the human mind on a large-scale within a reasonable period of time, such as within a second, a millisecond, microsecond, a real-time basis or other high speed required by the machines that generate the data, receive the data, convey the data, store the data and/or use the data.

One or more functions associated with the methods and/or processes described herein can require data to be manipulated in different ways within overlapping time spans. The human mind is not equipped to perform such different data manipulations independently, contemporaneously, in parallel, and/or on a coordinated basis within a reasonable period of time, such as within a second, a millisecond, microsecond, a real-time basis or other high speed required by the machines that generate the data, receive the data, convey the data, store the data and/or use the data.

One or more functions associated with the methods and/or processes described herein can be implemented in a system that is operable to electronically receive digital data via a wired or wireless communication network and/or to electronically transmit digital data via a wired or wireless communication network. Such receiving and transmitting cannot practically be performed by the human mind because the human mind is not equipped to electronically transmit or receive digital data, let alone to transmit and receive digital data via a wired or wireless communication network.

One or more functions associated with the methods and/or processes described herein can be implemented in a system that is operable to electronically store digital data in a memory device. Such storage cannot practically be performed by the human mind because the human mind is not equipped to electronically store digital data.

One or more functions associated with the methods and/or processes described herein may operate to cause an action by a processing module directly in response to a triggering event—without any intervening human interaction between the triggering event and the action. Any such actions may be identified as being performed “automatically”, “automatically based on” and/or “automatically in response to” such a triggering event. Furthermore, any such actions identified in such a fashion specifically preclude the operation of human activity with respect to these actions—even if the triggering event itself may be causally connected to a human activity of some kind.

While particular combinations of various functions and features of the one or more examples have been expressly described herein, other combinations of these features and functions are likewise possible. The present disclosure is not limited by the particular examples disclosed herein and expressly incorporates these other combinations.

What is claimed is:

1. A TDGₙ quantum circuit on n wires comprising:
a first set of circuits;
a plurality of CX gates appended to the first set of circuits to generate a plurality of additional circuits, wherein each of the additional circuits is formed by appending a CX gate of the plurality of CX gates in a corresponding one of a plurality of configurations to one circuit of a first set of circuits; and
a second set of circuits, wherein the second set of circuits is generated by:
(a) sequentially adding, ones of the additional circuits to the second set of circuits when a number of circuits in the second set of circuits is less than a first threshold number;
(b) when the number of circuits in the second set of circuits reaches the first maximum number, scoring the circuits added to the second set of circuits, removing a circuit from the second set of circuits based on a scoring criteria, and adding a next one of the additional circuits to the second set of circuits;
(c) continuing until each of the additional circuits have been added to the second set of circuits;
(d) remove duplicate circuits from the second set of circuits;
(e) when the number of circuits in the second set of circuits is greater than a second threshold number, removing circuits from the second set of circuits based on the scoring criteria until the number of circuits in the second set of circuits is equal to the second threshold number;
(f) scoring the second set of circuits based on a scoring threshold;
(g) when none of the second set of circuits reaches the scoring threshold, updating the first set of circuits as the second set of circuits, and repeating steps (a)-(f);
(h) when one of the second set of circuits reaches the scoring threshold, selecting a TDGₙ sequence of CX gates as the one of the second set of circuits that reaches the scoring threshold; and
(i) adding a plurality of phase gates, wherein each of the phase gates is inserted after a corresponding one of the CX gates of the TDGₙ sequence of CX gates on a corresponding one of the n wires.

2. The quantum circuit of claim 1, wherein n=5 and the TDGₙ sequence of CX gates comprises a SPA-TDG₅ sequence of CX gates on five wires.

3. The quantum circuit of claim 2, wherein each of the phase gates is inserted after a corresponding one of the CX gates of the SPA-TDG₅ sequence of CX gates on a corresponding one of the five wires.

4. The quantum circuit of claim 1, wherein n=4 and the TDGₙ sequence of CX gates comprises a SPA-TDG₄ sequence of CX gates on four wires.

5. The quantum circuit of claim 4, wherein each of the phase gates is inserted after a corresponding one of the CX gates of the SPA-TDG₄ sequence of CX gates on a corresponding one of the four wires.

6. The quantum circuit of claim 1, wherein n=5 and the TDGₙ sequence of CX gates comprises a NPA-TDG₅ sequence of CX gates on five wires.

7. The quantum circuit of claim 6, wherein each of the phase gates is inserted after a corresponding one of the CX gates of the NPA-TDG₅ sequence of CX gates on a corresponding one of the five wires.

8. The quantum circuit of claim 1, wherein n=4 and the TDGₙ sequence of CX gates comprises a NPA-TDG₄ sequence of CX gates on four wires.

9. The quantum circuit of claim 8, wherein each of the phase gates is inserted after a corresponding one of the CX gates of the NPA-TDG₄ sequence of CX gates on a corresponding one of the four wires.

10. The quantum circuit of claim 1, wherein z=5 and the SPAₙ sequence of CX gates comprises a WPA-TDGₙ.

11. A method for generating a TDGₙ quantum circuit on n wires, the method comprising:
(a) generating a first set of circuits;
(b) generating additional circuits, wherein each of the additional circuits is formed by appending a CX gate in a corresponding one of a plurality of configurations to one circuit of the first set of circuits;
(c) generating a second set of circuits by:
(d) sequentially adding, ones of the additional circuits to the second set of circuits when a number of circuits in the second set of circuits is less than a first threshold number;
(e) when the number of circuits in the second set of circuits reaches the first maximum number, scoring the circuits added to the second set of circuits, removing a circuit from the second set of circuits based on a scoring criteria, and adding a next one of the additional circuits to the second set of circuits;
(f) continuing until each of the additional circuits have been added to the second set of circuits;
(g) remove duplicate circuits from the second set of circuits;
(h) when the number of circuits in the second set of circuits is greater than a second threshold number, removing circuits from the second set of circuits based on the scoring criteria until the number of circuits in the second set of circuits is equal to the second threshold number;
(i) scoring the second set of circuits based on a scoring threshold;
(j) when none of the second set of circuits reaches the scoring threshold, updating the first set of circuits as the second set of circuits, and repeating steps (d)-(i);
(k) when one of the second set of circuits reaches the scoring threshold, selecting a TDGₙ sequence of CX gates as the one of the second set of circuits that reaches the scoring threshold; and
(1) adding a plurality of phase gates, wherein each of the phase gates is inserted after a corresponding one of the CX gates of the TDGₙ sequence of CX gates on a corresponding one of the n wires.

12. The method of claim 11, wherein n=5 and the TDGₙ sequence of CX gates comprises a SPA-TDG₅ sequence of CX gates on five wires.

13. The method of claim 12, wherein each of the phase gates is inserted after a corresponding one of the CX gates of the SPA-TDG₅ sequence of CX gates on a corresponding one of the five wires.

14. The method of claim 11, wherein n=4 and the TDGₙ sequence of CX gates comprises a SPA-TDG₄ sequence of CX gates on four wires.

15. The method of claim 14, wherein each of the phase gates is inserted after a corresponding one of the CX gates of the SPA-TDG₄ sequence of CX gates on a corresponding one of the four wires.

16. The method of claim 11, wherein n=5 and the TDGₙ sequence of CX gates comprises a NPA-TDG₅ sequence of CX gates on five wires.

17. The method of claim 16, wherein each of the phase gates is inserted after a corresponding one of the CX gates of the NPA-TDG₅ sequence of CX gates on a corresponding one of the five wires.

18. The method of claim 11, wherein n=4 and the TDGₙ sequence of CX gates comprises a NPA-TDG₄ sequence of CX gates on four wires.

19. The method of claim 18, wherein each of the phase gates is inserted after a corresponding one of the CX gates of the NPA-TDG₄ sequence of CX gates on a corresponding one of the four wires.

20. The method of claim 11, wherein z=5 and the SPAₙ sequence of CX gates comprises a WPA-TDGₙ.
